(19) United States
(12) Patent Application Publication
(10) Pub. No.: US 2013/0276679 A1
(43) Pub. Date: Oct. 24, 2013

(54) APPARATUS AND SYSTEM FOR PROVIDING SECURE STORAGE

(71) Applicant: TRACHTE BUILDING SYSTEMS, INC., (US)

(72) Inventors: Joshua J. Kroeplien, Sun Prairie, WI (US); Theodore A. Sempf, Sun Prairie, WI (US)

(21) Appl. No.: 13/838,055

(22) Filed: Mar. 15, 2013

Related U.S. Application Data
(60) Provisional application No. 61/613,484, filed on Mar. 20, 2012.

(51) Int. Cl. A47F 7/00; E05G 1/026

(52) U.S. Cl. CPC A47F 7/00; E05G 1/026
USPC 109/73; 211/13.1

(57) ABSTRACT

An apparatus and system for secure storage is disclosed. The apparatus and system includes a storage system, a door assembly, a pair of door guides for guiding the door assembly as it opens and closes, and side and rear security panels for enclosing the storage system.

### CROSS-REFERENCE TO RELATED APPLICATIONS

This application claims priority to U.S. Provisional Patent Application Ser. No. 61/613,484, filed Mar. 20, 2012, entitled “Apparatus and System for Providing Secure Storage,” the entire contents of which is hereby incorporated by reference in its entirety.

### FIELD OF THE INVENTION

The present invention relates generally to an apparatus and system for securely storing goods and other materials. More specifically, it relates to an apparatus and system for securely storing goods and other materials in a pallet racking or other shelving or storage system.

### BACKGROUND OF THE INVENTION

Pallet racks and pallet racking systems are among the most commonly used means of storage in use today. They are used in virtually every industry in every part of the world and have become an essential component of most modern warehouses, manufacturing facilities, retail centers, and other storage and distribution facilities. In essence, where ever there is a need to store goods and other materials, there is probably a pallet rack and pallet racking system being employed to do so.

There are numerous styles and types of pallet racking in use today, all of which allow for the storage of palletized goods and materials in horizontal rows with multiple levels. Selective pallet racking, for example, is one of the most common types of pallet racking and is what is typically thought of when the need arises for industrial and commercial type storage racking. These types of pallet racks are normally composed of several individual pieces connected together to form an entire storage system.

The two most common components of any pallet racking system are the vertical upright frames and the horizontal load beams or cross members. The vertical upright frames are large vertical pieces that form the walls of the racking structure and define how high and how deep the pallet racking will be. Upright frame heights can range from 72″ to 192″, but can be shorter or higher depending on the particular storage application and the particular goods to be stored. The depths of these frames generally range from 36″ to 48″, but again, can be shallower or deeper depending on the particular storage application and the particular goods to be stored.

A typical upright frame features a pair of vertical upright posts or columns which are usually tubular in shape. The two vertical upright columns are connected to each other by way of horizontal and diagonal braces, commonly referred to as upright frame lacing. The upright frame lacing is usually welded or bolted between the two vertical upright columns thereby forming a complete upright frame.

Each vertical upright column typically includes a series of keyholes or slots, evenly spaced apart on the outside surfaces of the columns. These slots are typically teardrop in shape and are used for attaching the horizontal load beams to the upright frames at the desired levels.

The horizontal load beams or cross members are used to connect adjacent vertical upright frames to each other and to create levels or shelves on which palletized goods and/or other items can be stored. These load beams are also typically tubular in shape and typically feature a notched-out step that is used for supporting accessory pieces such as decking or cross bars.

Two vertical upright frames and at least four horizontal load beams are typically required to make one section of pallet racking. The storage area or space between the upright frames is referred to as the “storage bay” or as simply the “bay.” Thus, each storage bay is surrounded by two upright frames. Additional sections (and therefore additional storage bays) can be added by adding additional vertical upright frames and additional horizontal load beams to the racking structure.

The width of a pallet rack storage bay (e.g., the horizontal distance between vertical upright frames) will also vary depending on the particular application and the particular goods to be stored on the pallet rack. In some applications, the width of the bay may be 48″ or less. In other applications, the bay may be 144″ or wider.

As previously mentioned, decking can be added to the pallet racking (the decking is typically supported between adjacent horizontal load beams by the notched-out steps on the load beams) to provide additional horizontal shelving surfaces for the pallet rack. Pallet rack decking is often made of wire, but can alternatively be made of particle board, plywood, solid steel or numerous other materials. Decking is extremely useful for storing non-palletized goods and materials.

A typical prior art pallet rack 100 having a single storage bay 102 is shown in FIG. 1. The pallet rack of FIG. 1 includes left and right vertical upright frames 104, 106, one on each end of pallet rack 100. As previously mentioned, the height and depth of upright frames 104 and 106, and the width of storage bay 102, will vary depending on the particular application and the particular goods to be stored on pallet rack 100.

Each vertical upright frame 104, 106 includes a front vertical upright post or column 108 and a rear vertical upright post or column 110. Vertical upright columns 108 and 110 are connected to each other using horizontal brace members 112, 114, and 116. Added strength and stability is provided to each upright frame 104, 106 using diagonal braces 118, 120.

Vertical upright frames 104, 106 are connected to each other using a plurality of horizontal load beams or cross members. For example, pallet rack 100 shown in FIG. 1 includes an upper pair of horizontal load beams 122, 124, a middle pair of horizontal load beams 126, 128, and a lower pair of horizontal load beams 130, 132.

Pallet rack 100 also includes a plurality of decking cross members 134 between the upper pair of horizontal load beams 122, 124. Decking cross members 134 provide a useful shelf for use in those situations where pallet rack 100 is used to store goods that are not contained on pallets.

FIG. 2 shows a second prior art pallet rack 200 having multiple storage bays 202, 204, 206. Pallet rack 200 includes a plurality of vertical upright frames 258, 260, 262, 264. Vertical upright frames 258 and 260 are disposed on the left and right ends respectively of pallet rack 200 while vertical upright frames 262 and 264 are disposed in the middle of pallet rack 200. Each vertical upright frame 258, 260, 262, 264 includes a front vertical upright post or column 208 and a rear vertical upright post or column 210. The remaining construction of each vertical upright frame 258 through 264 is identical to the construction of vertical upright frames 104 and 106 of pallet rack 100 and will not be described further herein.

Pallet rack 200 includes three separate bays 202, 204 and 206. Bay 202 is disposed between left vertical upright frame 258 and middle upright frame 262, bay 204 is disposed between right vertical upright frame 260 and middle upright frame 264, and middle storage bay 206 is disposed between the two middle vertical upright frames 262 and 264. As was the case with single-bay pallet rack 100, the height and depth of vertical upright frames 258 through 264 and the width of bays 202 through 206 will vary depending on the particular application and the particular goods to be stored on pallet rack 200.

The various vertical upright frames of multi-bay pallet rack 200 are connected to each other using horizontal load beams in the same manner that upright frames 104, 106 are connected to each other in pallet rack 100. For example, adjacent vertical upright frames 258 and 262 are connected to each other using an upper pair of horizontal load beams 222, 224, a middle pair of horizontal load beams 226, 228 and a lower pair of horizontal load beams 230, 232. Similarly, adjacent vertical upright frames 262 and 264 are connected to each other using an upper pair of horizontal load beams 234, 236, a middle pair of horizontal load beams 238, 240 and a lower pair of horizontal load beams 242, 244. Finally, adjacent vertical upright frames 260 and 264 are connected to each other using an upper pair of horizontal load beams 246, 248, a middle pair of horizontal load beams 250, 252 and a lower pair of horizontal load beams 254, 256.

As previously discussed, goods are typically stored on pallet racks on wooden pallets. Pallets containing the goods to be stored are generally placed in the bay with the bottom of the pallet resting on the horizontal load beams. Forklift trucks are typically used to place the loaded pallets onto these racks for storage at the various levels and to remove the palletized goods when needed from the pallet rack.

One of the drawbacks to traditional pallet racking systems is that the structures are generally open and unsecured. This means that unlimited and unrestricted access is generally available to the goods and materials stored in these racking systems. In many cases, this poses no problems or issues. However, in other situations, this may create a significant problem.

For example, if the goods and materials stored on a pallet rack are of high value or prone to theft, then having an open and unsecured storage system can result in significant losses due to theft. In addition, there may be regulatory requirements, such as in the case of pharmaceuticals or hazardous materials, that require such items to be stored in secure storage locations with restricted access. In such cases, storing these items on open and unsecured pallet racking systems may not be possible because of these regulatory restrictions. It is desirable therefore to have a pallet racking system where the stored goods are secured such that access to the stored goods can be limited and/or restricted.

Currently, the options for securing stored goods on pallet racking and other similar shelving systems are limited. These options generally involve enclosing the pallet racking, or a portion of the pallet racking, such as a single storage bay, within a wire mesh cage or enclosure. Manually operated wire mesh doors, which can be locked, are located on the front of the cages to allow access to the stored goods. These prior art wire mesh systems suffer from many drawbacks, however.

One such drawback is that the wire mesh doors on these systems typically open outward into the aisle in front of the pallet rack, or slide out of position into the next storage bay. This tends to impede access to the aisle or the adjacent storage bay depending on the type of door being used. Impeding the aisles in front of the pallet racking system can be especially problematic because these aisles, which in many cases are narrow, typically provide the main and only travel path for the forklift trucks that load and unload palletized goods onto and off of the pallet racking system.

Another drawback to the doors on these prior art wire mesh systems is that the doors are manually operated. This means that forklift operators have to dismount from their equipment in order to open these doors to gain access to the goods and materials stored inside of the secure enclosure.

Existing prior art pallet rack security systems also do not provide any visual security for the goods and materials stored on the pallet racking. Because wire mesh is typically used in these systems, the goods stored inside of the enclosure are readily visible. This allows for easy identification of theft prone goods by individuals who may be inclined to steal these goods. In addition, once the goods are identified, these prior art wire mesh security systems are easily accessed using readily available tools such as bolt cutters, wire cutters, or other readily available hand tools.

Another drawback to wire mesh pallet rack security enclosures is that, by their very nature, these systems are not weather tight. They do not, as a result, provide stored goods with any protection from the outdoor elements such as from wind and rain.

It is desirable, therefore to have a security apparatus and system for pallet racks and other storage structures that does not suffer from the drawbacks present with the prior art wire mesh systems. Such an apparatus and system would preferably have, for example, access doors that open without blocking aisles and other travel paths, or adjacent storage areas or racks. It would also be desirable for the doors on such a system to be automatic doors operated by, for example, a motor. Preferably, these motor operated automatic doors can be activated using a button, a keypad, or a remote control device, thereby allowing access to the secured goods without requiring the forklift truck operator to dismount from his or her equipment.

It is also desirable to have a security apparatus and system that provides visual security in that the stored goods cannot be seen from outside of the security apparatus and system. It is also desirable to have a security apparatus and system that cannot be accessed using readily available hand tools. Preferably, the security apparatus and system will include tamper resistant fasteners to prevent someone without authority from entering or disassembling the security apparatus and system.

It is also desirable to have a security apparatus and system that provides 360° of protection around the entire pallet racking or other storage structure. Preferably, such an apparatus and system will be designed and configured to mount directly to standard pallet racking of various sizes to create a secure storage area. The security apparatus and system will also preferably be weather tight allowing for outdoor use.

### SUMMARY OF THE PRESENT INVENTION

According to a first aspect of the invention, an apparatus and system for secure storage includes a storage system, a door assembly, a pair of door guides for guiding the door assembly as it opens and closes. In one embodiment, the apparatus and system includes side and rear security panels for enclosing the storage system. In another embodiment of the present invention, the storage system is a pallet racking system. In yet another embodiment of the present invention, the door assembly is a roll-up door assembly.

According to a second aspect of the invention, an apparatus and system for securing a storage system includes a door assembly, a pair of door guides for guiding the door assembly as it opens and closes, and side and rear security panels for enclosing the storage system. In one embodiment of the present invention, the storage system is a pallet racking system. In another embodiment of the present invention, the door assembly is a roll-up door assembly.

Other principal features and advantages of the invention will become apparent to those skilled in the art upon review of the following drawings, the detailed description and the appended claims.

### BRIEF DESCRIPTION OF THE DRAWINGS

The drawings, which constitute a part of the specification, are as follows:

FIG. 1 shows a front, top and right side isometric view of a prior art single-bay pallet rack;

FIG. 2 shows a front, top and right side isometric view of a prior art multi-bay pallet rack;

FIG. 3 shows a rear, top and right side exploded isometric view of an apparatus and system for secure storage in accordance with one embodiment of the present invention;

FIG. 4A shows a partially cut-away front, top and right side detailed isometric view of an angled door mounting bracket and an upper door guide mounting bracket in accordance with one embodiment of the present invention;

FIG. 4B shows a partially cut-away detailed front plan view of the angled door mounting and upper door guide mounting brackets shown in FIG. 4A;

FIG. 4C shows a partially cut-away detailed top plan view of the angled door mounting and upper door guide mounting brackets shown in FIG. 4A;

FIG. 5A shows a partially cut-away front, top and right side detailed isometric view of a lower door guide mounting bracket in accordance with one embodiment of the present invention;

FIG. 5B shows a partially cut-away detailed front plan view of the lower door guide mounting bracket shown in FIG. 5A;

FIG. 5C shows a partially cut-away detailed top sectional view of the lower door guide mounting bracket shown in FIG. 5A;

FIG. 6A shows a partially cut-away front, top and right side detailed isometric view of a mounted door guide in accordance with one embodiment of the present invention;

FIG. 6B shows a partially cut-away detailed front plan view of the mounted door guide shown in FIG. 6A;

FIG. 6C shows a partially cut-away detailed top plan view of the mounted door guide shown in FIG. 6A;

FIG. 7A shows a front, top and right side isometric view of an apparatus and system for secure storage in accordance with another embodiment of the present invention;

FIG. 7B is a top plan view of the apparatus shown in FIG. 7A;

FIG. 7C is a front elevation view of the apparatus shown in FIG. 7A;

FIG. 7D is a right side elevation view of the apparatus shown in FIG. 7A;

FIG. 7E is a rear elevation view of the apparatus shown in FIG. 7A;

FIG. 8A shows a partially cut-away front, top and right side detailed isometric view of a mounted corner jamb member and door guide in accordance with one embodiment of the present invention;

FIG. 8B shows a partially cut-away detailed front plan view of the mounted corner jamb member and door guide shown in FIG. 8A;

FIG. 8C shows a partially cut-away detailed top plan view of the mounted corner jamb member and door guide shown in FIG. 8A;

FIG. 9A shows a front, top and right side isometric view of an apparatus and system for secure storage in accordance with another embodiment of the present invention;

FIG. 9B shows a front, top and right side detailed isometric view of a jamb and door guide of the apparatus and system shown in FIG. 9A;

FIG. 10 shows a front, top and right side isometric view of an apparatus and system for secure storage in accordance with another embodiment of the present invention;

FIG. 11A shows a front, top and right side isometric view of an apparatus and system for secure storage in accordance with another embodiment of the present invention;

FIG. 11B is a top plan view of the apparatus shown in FIG. 11A;

FIG. 11C is a front elevation view of the apparatus shown in FIG. 11A;

FIG. 11D is a right side elevation view of the apparatus shown in FIG. 11A;

FIG. 11E is a rear elevation view of the apparatus shown in FIG. 11A;

FIG. 12 is a top, front and right side perspective view of an apparatus and system for secure storage in accordance with another embodiment of the present invention;

FIG. 13 is a front elevation view of the apparatus and system shown in FIG. 12;

FIG. 14 is a rear elevation view of the apparatus and system shown in FIG. 12;

FIG. 15 is a top plan view of the apparatus and system shown in FIG. 12;

FIG. 16 is a right side elevation view of the apparatus and system shown in FIG. 12; and

FIG. 17 is a left side elevation view of the apparatus and system shown in FIG. 12.

Before explaining at least one embodiment of the present invention in detail it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. Like reference numerals are used to indicate like components.

### DETAILED DESCRIPTION OF THE PREFERRED EMBODIMENTS

While the present invention will be illustrated with reference to a particular security apparatus and system for securing stored goods having particular configurations and particular features, the present invention is not limited to these configurations or to these features and other configurations and other features can be used. Also, although the present invention will be illustrated with reference to a pallet rack security system, the present invention may have use in other applications and other industries as well including with shelving and storage systems other than pallet racking systems.

Generally, the present invention involves an apparatus and system for securing goods stored in a storage apparatus or system such as in a pallet rack or pallet racking system. The apparatus includes a roll-up door having a corrugated steel curtain in one embodiment. Other embodiments have non-corrugated curtains and curtains made from materials other than steel or metal.

The roll-up door is disposed entirely inside of the pallet rack in one embodiment, preferably in a location that minimizes interference with the loading and unloading of palletized goods into and out of the pallet racking. The door is manually operated in one embodiment. In other embodiments of the present invention, the roll-up door is driven by a motor and drive assembly such as, for example, by a chain drive or belt drive. The door can be operated by way of a button, a key pad, or by way of a remote control device.

This roll-up door when closed, extends outward from inside of the pallet racking system. Door guides are provided on either side of the door to control the path of the sliding door as it is closed. The door guides are mounted to the structural uprights of the pallet racking system in this embodiment.

Door guides are provided in one embodiment for guiding the door as it opens and closes. These guides are disposed to permit the roll-up door to open and close without interference from the horizontal load beams and shelves of the pallet rack disposed directly behind the door. In other words, the door guides permit the roll-up door to clear the horizontal load beams and shelves of the pallet rack as the door opens and closes.

The security apparatus and system includes side and/or rear security panels in one embodiment. These security panels permit the pallet racking structure to be enclosed on the sides and on the back of the pallet racking structure. These panels are formed from corrugated metal panel sections in one embodiment of the present invention. In other embodiments, non-corrugated panels and panels made from materials other than metal are provided.

Corner trim members and jambs are provided to cover-up any gaps or openings that may be present at the corners of the pallet racking structure.

The security apparatus and system of the present invention can be configured in a multitude of ways to accommodate the security requirements for a particular application. For example, the security apparatus and system of the present invention can be configured to secure a single bay in a multi-bay pallet racking system. Alternatively, two or more bays in a multi-bay pallet rack can be individually and separately enclosed. In this case, each secured bay would be enclosed using a roll-up door, side panels and rear panels. Additional jambs and trim members are provided to cover up any gaps or openings that may be present between adjacent security enclosures. Additional jambs and trim members are also provided to cover up any gaps that may exist between adjacent security enclosures.

Alternatively, in another embodiment, two or more pallet rack storage bays could be enclosed in a single secure enclosure. In this embodiment, a single roll-up door spans across multiple storage bays and side panels, rear panels and corner jambs and trim members are provided to complete the enclosure. In an alternative embodiment, multiple roll-up doors are installed in adjacent storage bays. Jambs are provided in yet another embodiment to cover-up or enclose the openings between the adjacent doors, or to enclose a bay in a row of pallet racks, without impeding the functionality of adjacent, non-secure storage bays.

A roof structure is provided in another embodiment of the present invention to close off the top of the secure pallet rack enclosure in another embodiment of the present invention. The roof structure is weather tight in another embodiment of the present invention.

In one embodiment of the present invention, the pallet racking security apparatus mounts to the existing structural framework of the pallet racking system. Hidden and tamper resistant fasteners are used to attach the security apparatus to the pallet rack to help prevent unauthorized access to the stored goods in another embodiment.

In one or more examples of embodiments, the side and/or back panels may interlock. The panels may interlock with the pallet racking framework, or in the alternative may interlock with adjacent panels. In one example, the side panel may interlock with the back panel. Interlocking panels may be connected or coupled directly using a variety of coupling mechanisms, such as but not limited to, friction fit, tongue and groove, mortise and tenon, and so forth. In the alternative, one or more fasteners may be used.

In one or more examples of embodiments, an extender may be provided for the system front (e.g., door, jamb and header) and back panels. The extender provides a greater area for an existing pallet racking system to accommodate deep pallets. As a non-limiting example, the extender allows the pallet racking system to accommodate a 48 inch deep pallet on a 42 inch pallet shelf, yet continues to permit closure of the door and attachment of the various components and panels to provide the security of the enclosed bay.

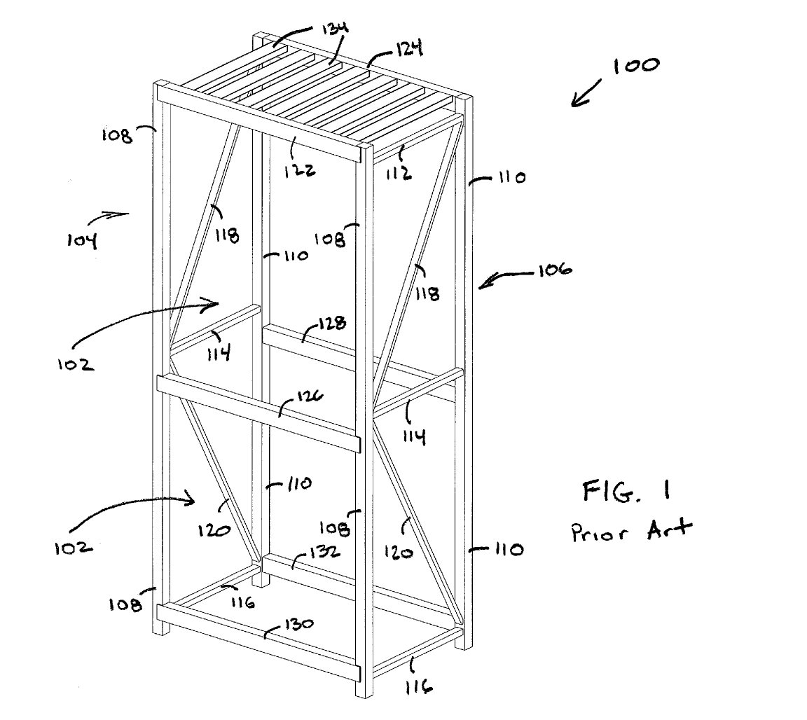

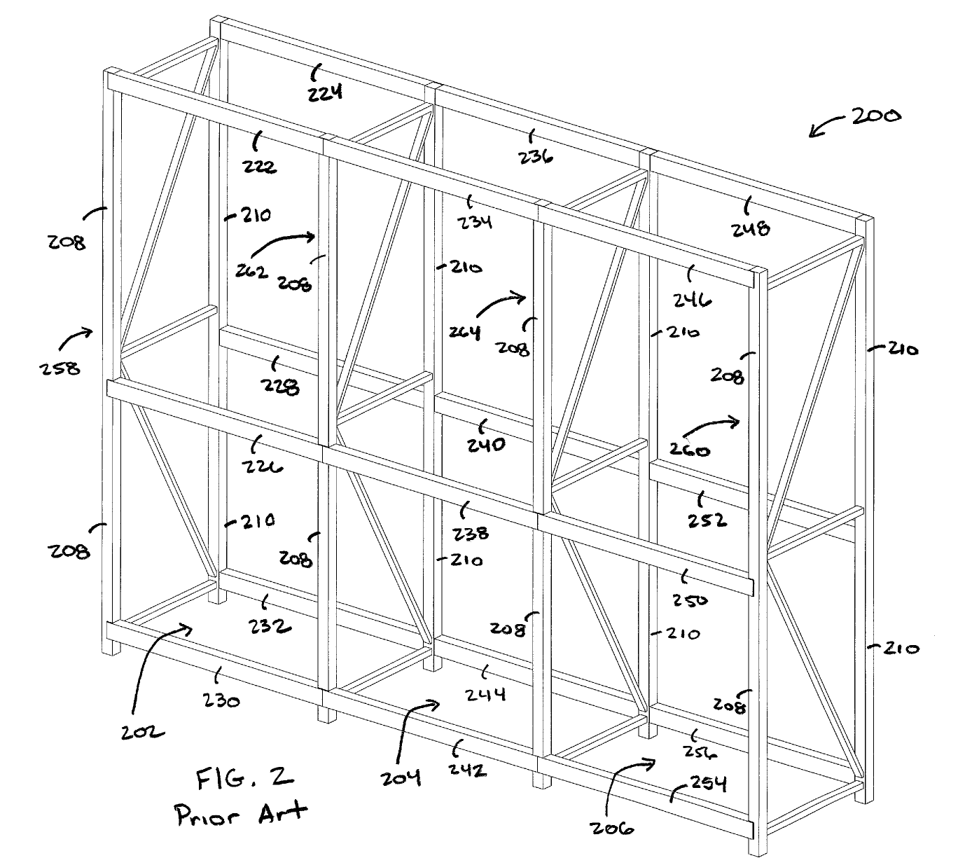

A pallet rack security apparatus and system 300 according to one embodiment of the present invention is shown in FIG. 3. Pallet rack security apparatus and system 300 is shown enclosing a single-bay pallet rack such as, for example, single-bay pallet rack 100 shown in FIG. 1. It should be understood that although security apparatus and system 300 is shown in FIG. 3 securing a single-bay pallet rack, pallet rack security system 300 and the present invention are not limited to use with only single-bay pallet racks. In other embodiments, pallet rack security apparatus and system 300 and the present invention are used with other types of pallet racks including with multi-bay pallet racks and systems. It should also be understood that the present invention is not necessarily limited to use with pallet racks or pallet rack systems. Other embodiments of the present invention are configured for use with, and may include, the pallet racks and pallet racking systems, or shelving and storage structures and systems other than pallet racks and pallet racking systems.

In the embodiment shown in FIG. 3, pallet rack security apparatus and system 300 includes a roll-up door assembly (also known as a rolling curtain door assembly) 302, left and right side security panels 304, 306, back or rear security panel 308, and header panel 310. In addition, pallet rack security apparatus and system 300 also includes a pair of door mounting brackets 312, 314, a pair of door guides 316, 318, upper door guide mounting brackets 320, 322, and lower door guide mounting brackets 324, 326. Pallet rack security apparatus and system 300 also includes various corner jambs 328 and rear trim members 330 in the embodiment shown in FIG. 3.

It should also be noted that although pallet rack security system 300 is shown having certain components and certain assemblies, other embodiments of the present invention may include more or less of these components and assemblies or may include other or additional components and assemblies. For example, although pallet rack security system 300 is shown in FIG. 3 having side panels 304, 306 and rear panel 308, other embodiments of the present invention may only include some of these panels or may include none of these panels. In cases where the rear of the pallet rack is positioned next to the wall of a building or is secured to the wall of a building, there may not be a need for rear panel 308 for example. Likewise, in those situations where the sides of the underlying pallet rack are adjacent to a building wall, there may not be a need for one or both of side panels 304, 306.

In the embodiment of the present invention shown in FIG. 3, roll-up door assembly 302 is a live axle door assembly and includes an axle 332, two or more circular drums 334 (the number of drums will typically depend on the length of the door assembly) attached to axle 332, a corrugated door curtain 336 which winds around axle 332 and drums 334, one or more springs 338 (again, the number of springs will typically depend on the length of the door assembly) which provide the tension for door assembly 302, and a tension wheel 340 which allows for adjustment of the tension on spring 338. Roll-up door assemblies of the type shown in pallet rack security apparatus and system 300 are readily available and will not be described further herein. For example, one such roll-up door assembly which could be used is the Model 966 rolling steel curtain door supplied by Trac-Rite Door of Sun Prairie, Wis.

It should also be understood that although pallet rack security apparatus and system 300 is shown having a particular type of door assembly having particular features, the present invention is not necessarily limited to this type of door assembly or to a door assembly having these features. In other embodiments of the present invention, different types of doors are used having different types of features. For example, in other embodiments of the present invention, a non-roll-up door assembly is provided or a standard type multi-sectional garage door is used.

Roll-up door assembly 302 in the embodiment of FIG. 3 is mounted to pallet rack 100 using angled door mounting brackets 312, 314 and upper door guide mounting brackets 320, 322. More specifically, each angled door mounting bracket 312, 314 is positioned on a respective end of axle 332 of door assembly 302 by inserting the ends of axle 332 through an axle opening 342 in each bracket 312, 314. Brackets 312, 314 are held in place on axle 332 using a washer and a cotter key (not shown) inserted through axle 332.

A spring loaded pawl (not shown) is attached to angle bracket 314 and disposed for engagement with tension wheel 340 in this embodiment to allow for controlled adjustment of tension wheel 340. In addition to the pawl, a metal door stop (not shown) is also attached to each door bracket 312, 314 to provide a stop for door curtain 336 as it is rolled-up.

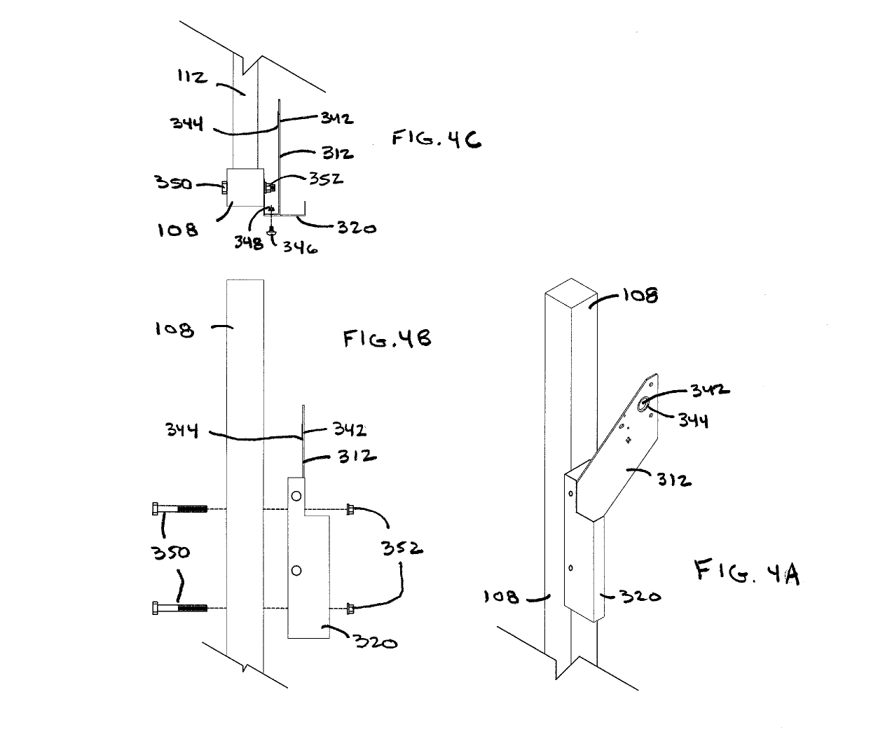

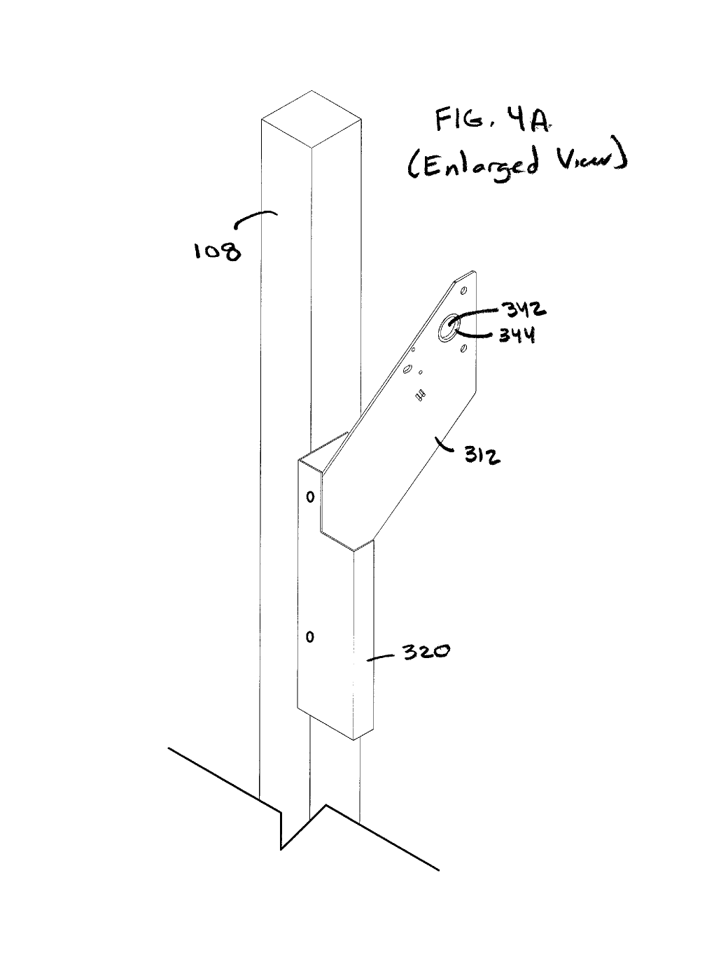

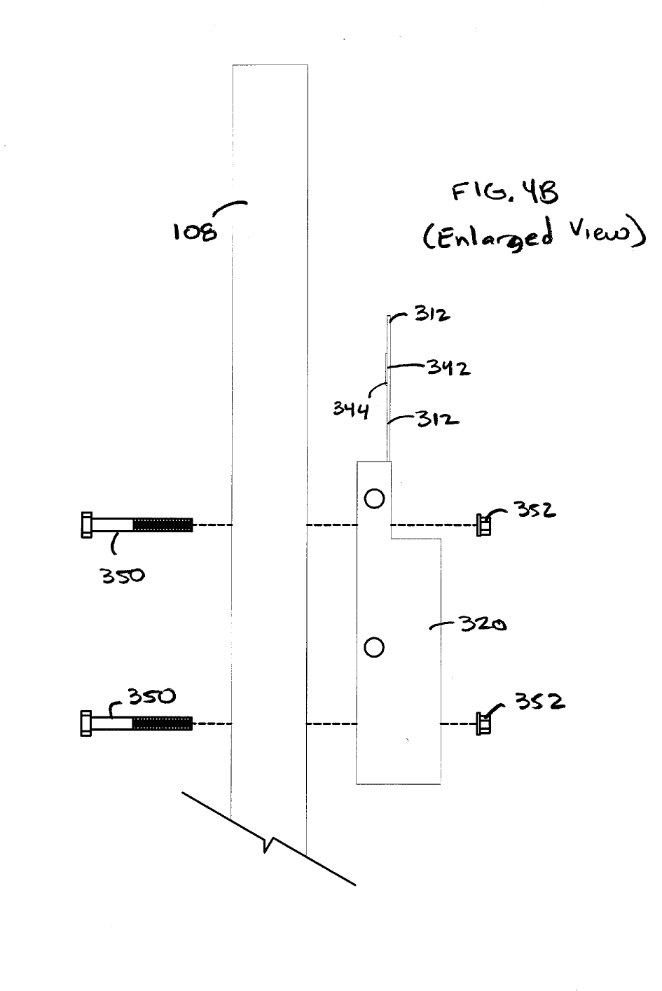

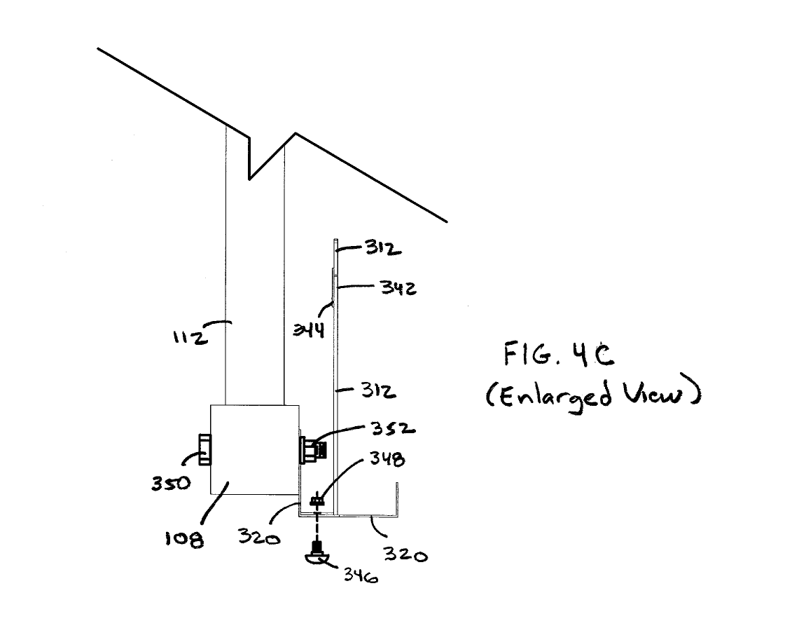

Angled door mounting brackets 312, 314 are formed from 14-gauge cold-formed zinc-coated steel in one embodiment and include a grease-packed ball bearing assembly 344 which is press fit into axle opening 342 in brackets 312, 314 (see FIGS. 4CA and 6A). The bearing assembly is provided in this embodiment to allow for smooth rotational movement of axle 332 as roll-up door assembly 202 is opened and closed. Other materials are used to form or make the angled door mounting brackets in other embodiments of the present invention.

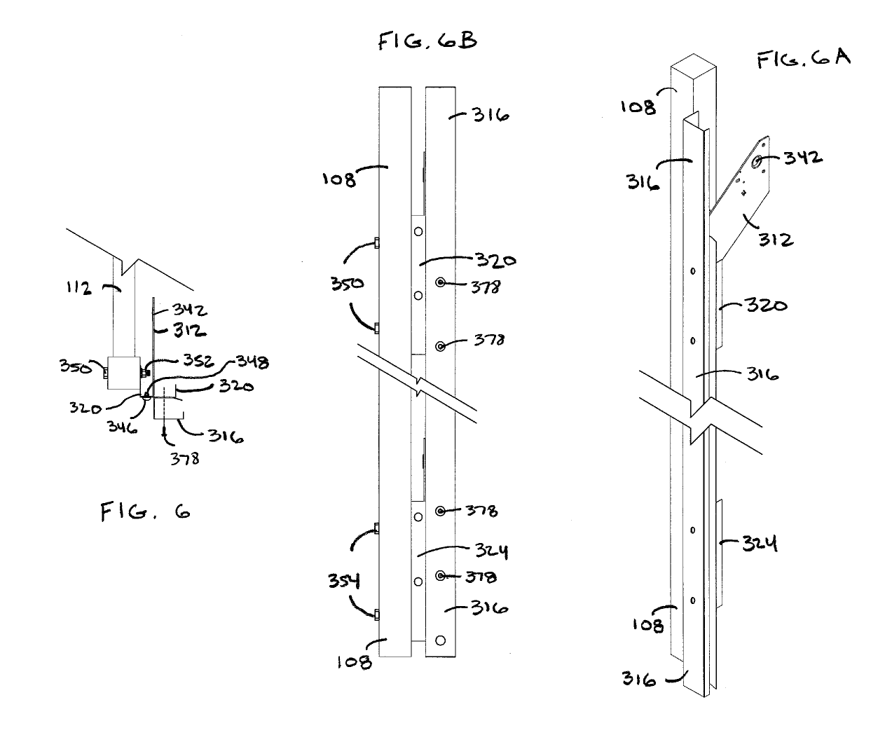

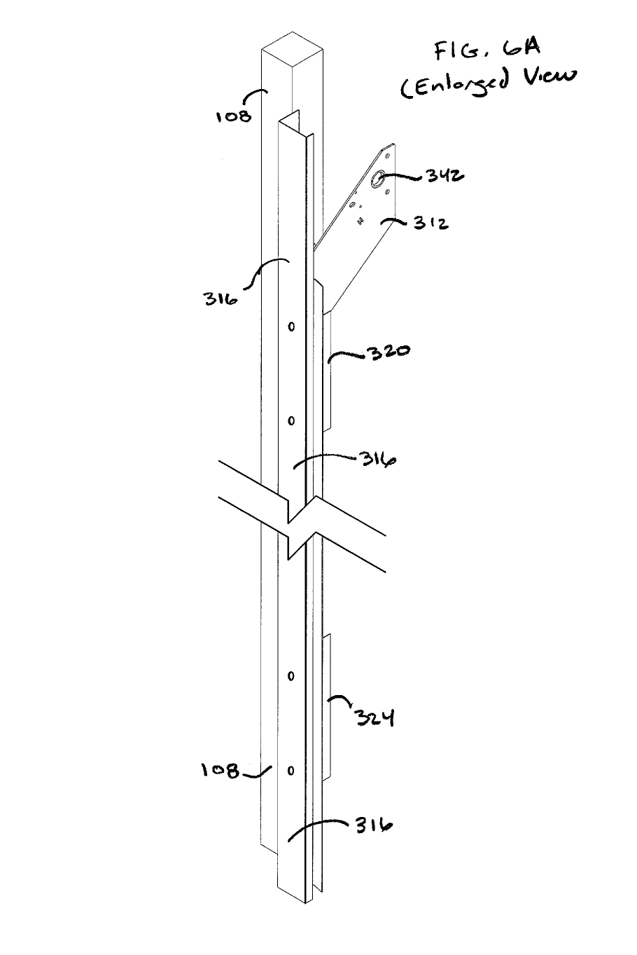

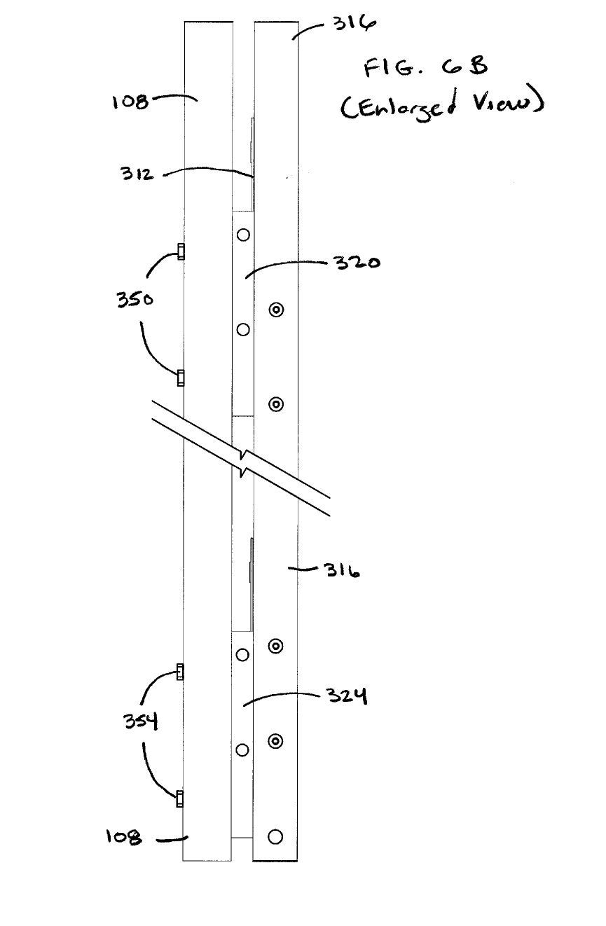

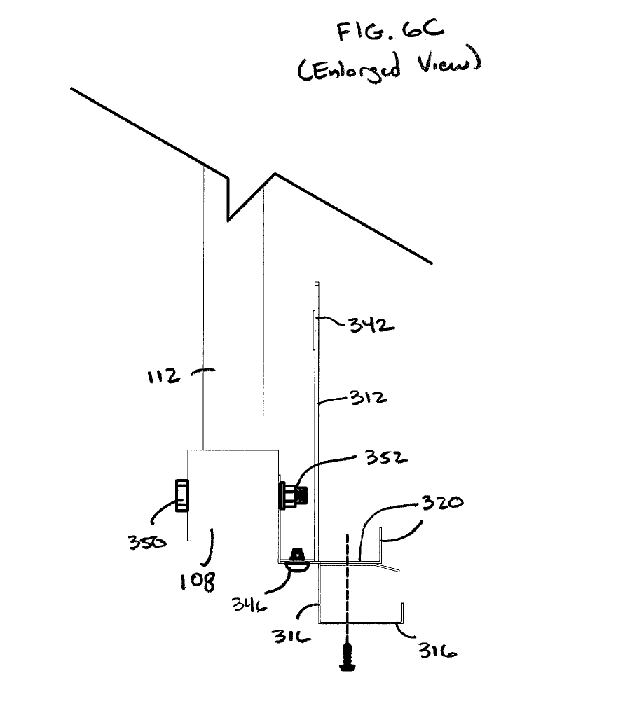

Left and right angled door mounting brackets 312, 314 are each attached to a corresponding left and right “J-shaped” upper door guide mounting bracket 320, 322 using conventional fasteners such as bolts 346 and nuts 348 (see FIGS. 4C and 6C). Left and right upper door guide mounting brackets 320, 322 in turn are each mounted to a corresponding left and right front vertical upright column 108 of pallet rack 100, also using conventional fasteners such as bolts 350 and nuts 352 (see FIGS. 4B and 6B).

When properly mounted, roll-up door assembly 302 is positioned completely inside of the storage bay of pallet rack 100. More specifically, door assembly 302 is positioned rearward of front vertical upright posts 108 and just below upper horizontal load beam 122. In this position, door assembly 302 is positioned so as to be completely inside of pallet rack 100 and yet in a position so as to minimize interference with the loading and unloading of pallets and goods into and out of the storage bay of pallet rack 100.

It should be understood that in other embodiments of the present invention, door assembly 302 is disposed in locations other than as shown in FIG. 3. For example, in other embodiments of the present invention, door assembly 302 is disposed partially or completely outside of pallet rack 100.

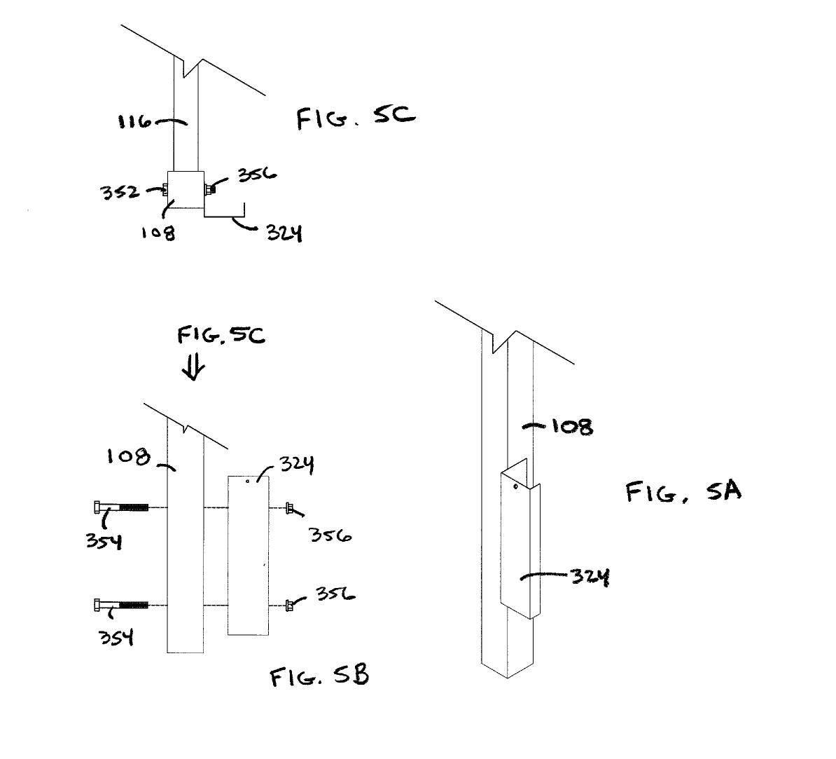

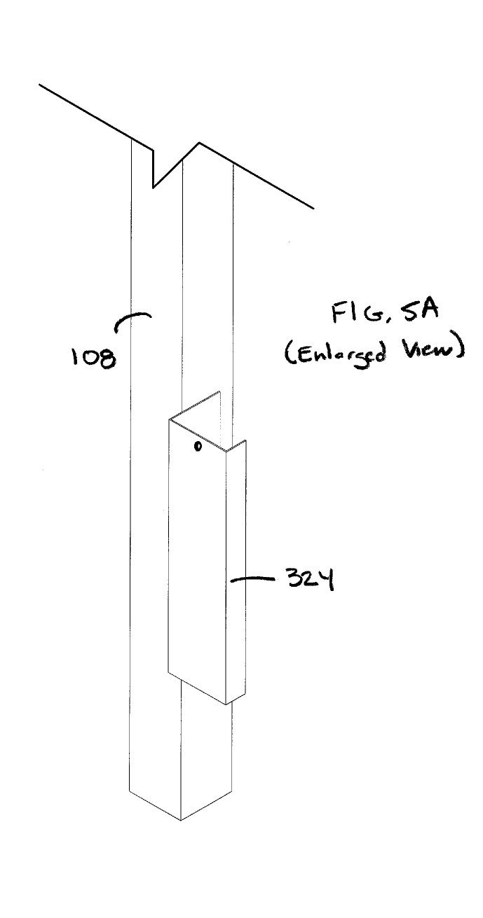

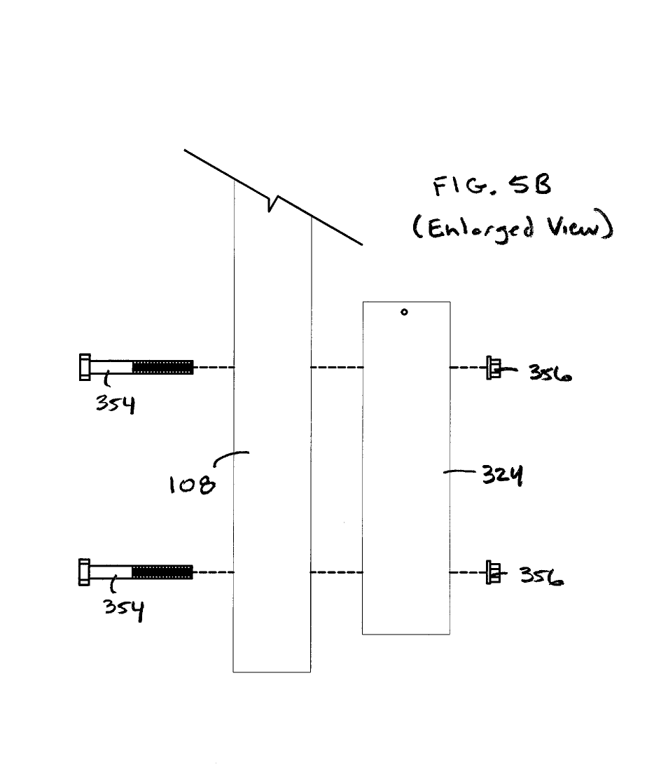

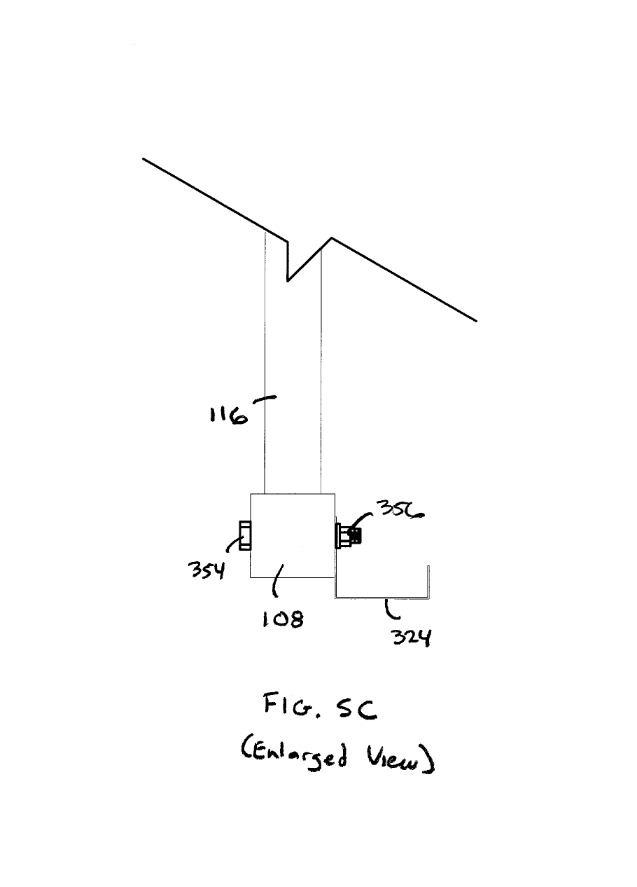

In addition to upper door guide mounting brackets 320, 322, left and right “J-shaped” lower guide mounting brackets 324, 326 are also mounted to front vertical upright posts 108 near the bottom of pallet rack 100 using conventional fasteners such as bolts 354 and nuts 356 (see FIGS. 5B and 6B). Upper and lower guide mounting brackets 320, 322, 324 and 326 are all formed from 16-gauge galvanized steel in one embodiment of the present invention. Other materials are used to form or make the upper and lower guide mounting brackets in other embodiments of the present invention.

It should be noted that in this embodiment, upper and lower guide mounting brackets 320, 322, 324 and 326 are configured such that when properly mounted to front vertical upright posts 108, each of these mounting brackets extends outward from the front face of vertical upright posts 108 and thus outward from the front of pallet rack 100 (see FIGS. 4C, 5C and 6C). The reason for this well be more fully explained below.

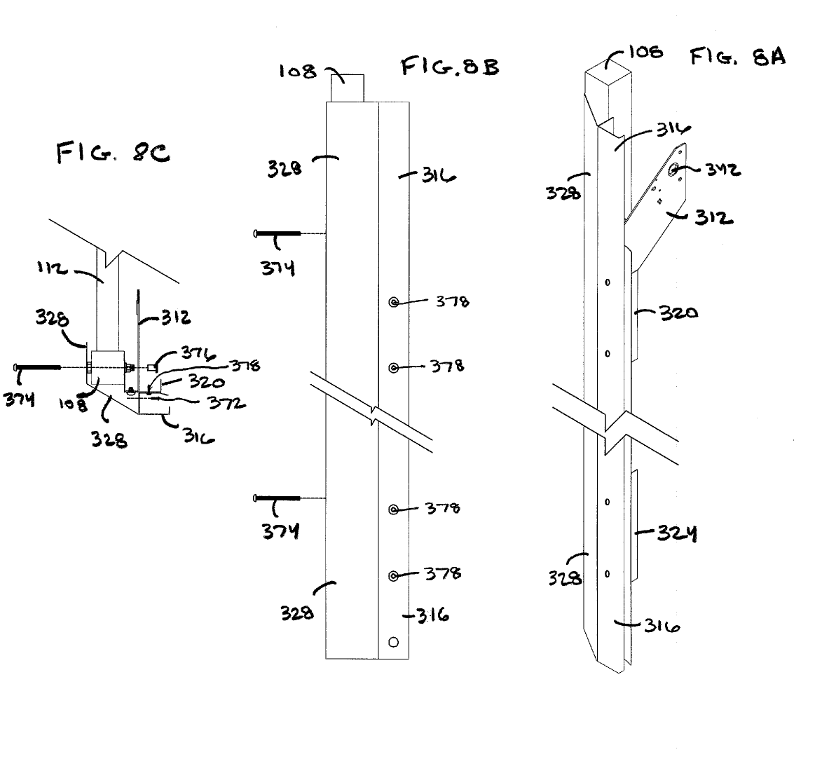

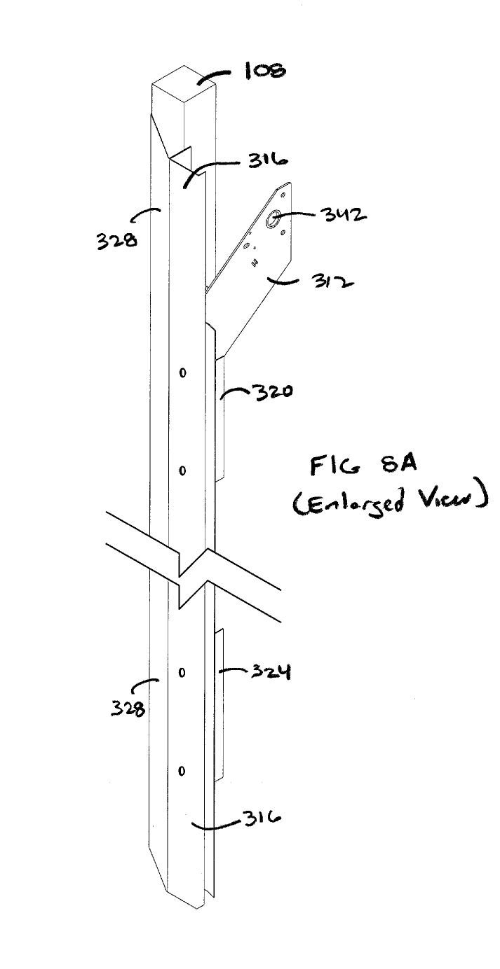

Left and right side door guides 316, 318 are mounted to pallet rack 100 in this embodiment using upper and lower door guide mounting brackets 320, 322, 324 and 326. More specifically, left side door guide 316 is fastened to its corresponding upper and lower door guide mounting brackets 320, 324 using Tek screws 378 (see FIGS. 6 and 8) so as to run vertical in length and so as to be positioned slightly outward from, and to the right of, left front vertical upright post 108 of pallet rack 100 (see FIGS. 3, 6 and 8). Similarly, right side door guide 318 is fastened to its corresponding upper and lower guide mounting brackets 322, 326 so as to run vertical in length and so as to be positioned slightly outward from, and to the left of, right front vertical upright post 108 of pallet rack 100 (see FIGS. 3, 6 and 8).

Positioning door guides 316 and 318 just to the left and right of their corresponding front vertical upright posts 108 allows door curtain 336 of door assembly 302 to be pulled outward between left and right front vertical upright posts 108 and into door guides 316, 318. Positioning guides 316, 318 outward from vertical upright posts 108 and pallet rack 100 allows door curtain 336 to clear middle horizontal load beam 126 and lower horizontal load beam 130 when door assembly 302 is in the un-rolled or closed position.

Door guides 316, 318 in one embodiment of the present invention are formed from 18-gauge zinc coated steel, 1½″ deep. Other materials are used to form or make the door guides in other embodiments of the present invention. The lengthwise edges of each door guide are covered with a polypropylene guide runner with pre-bent tabs (not shown). The polypropylene guide runners are provided to prevent the metal edges of the door curtain from rubbing against the metal surfaces of the door guides in this embodiment.

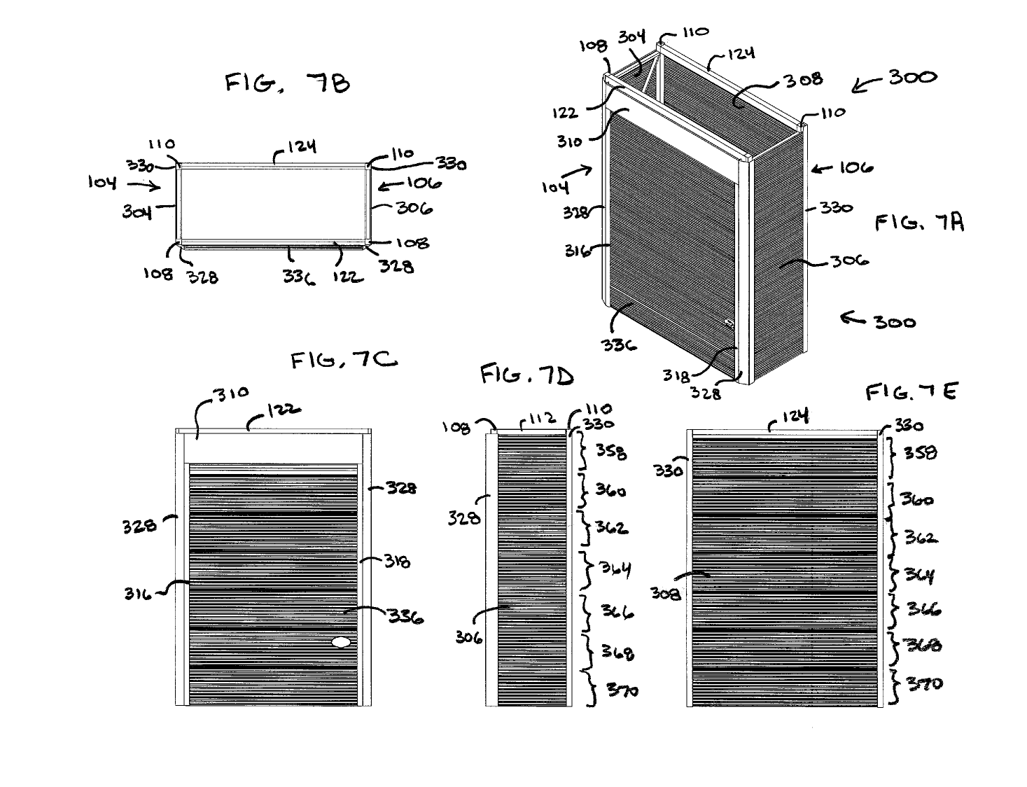

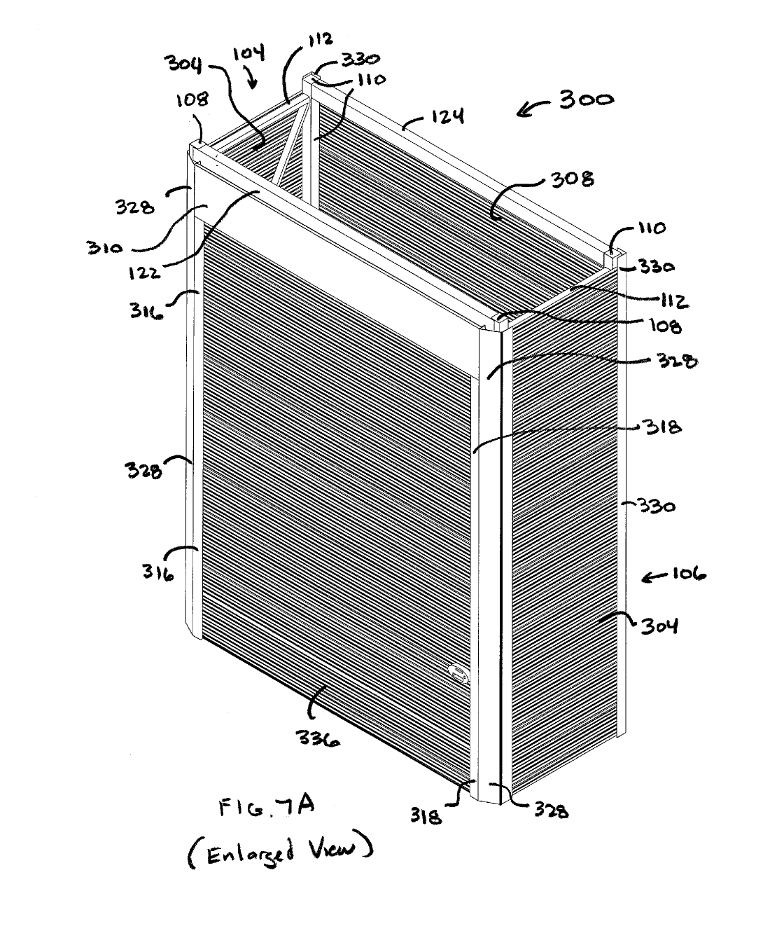

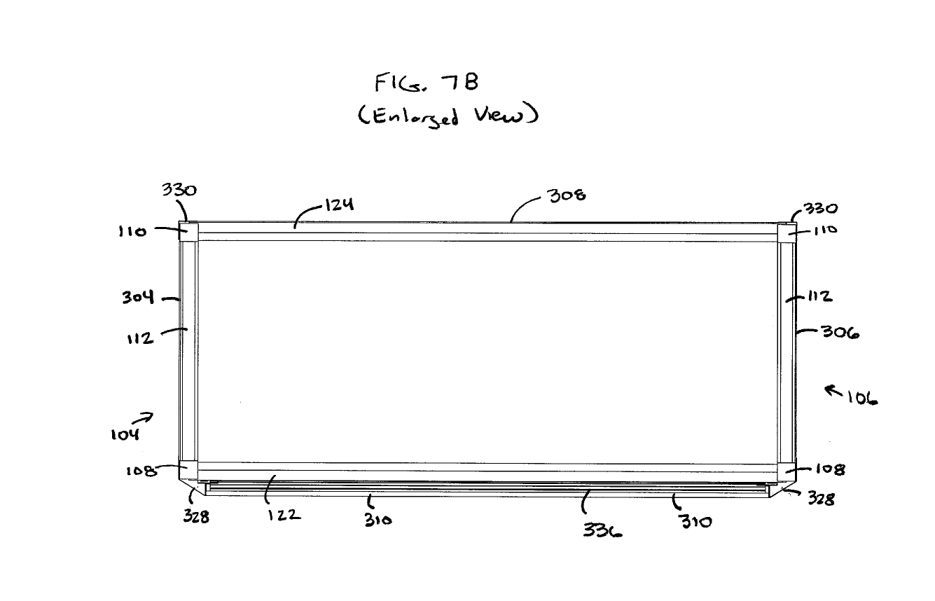

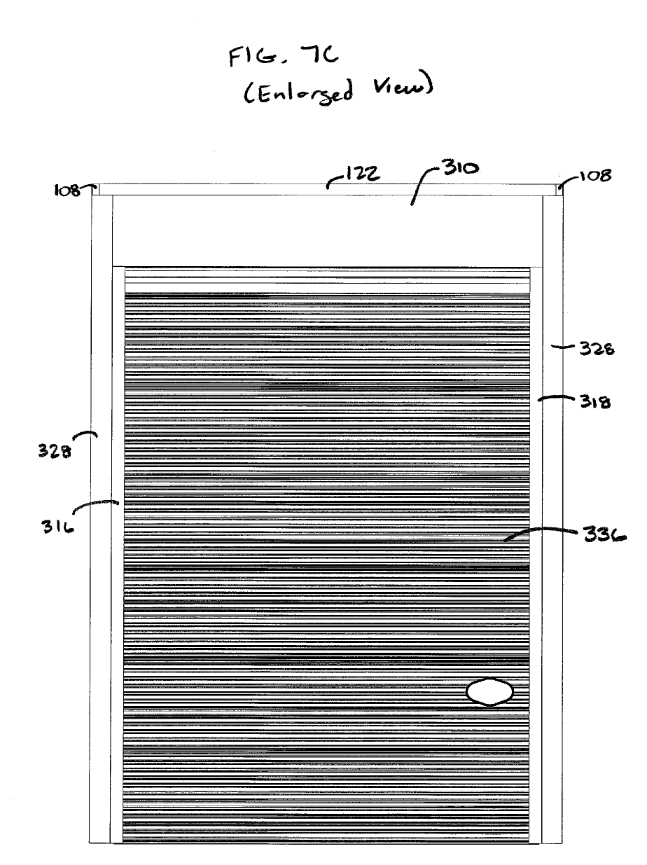

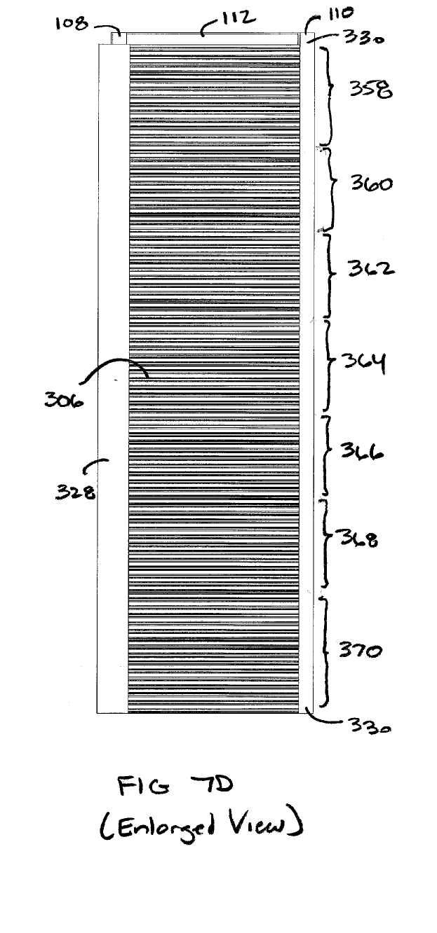

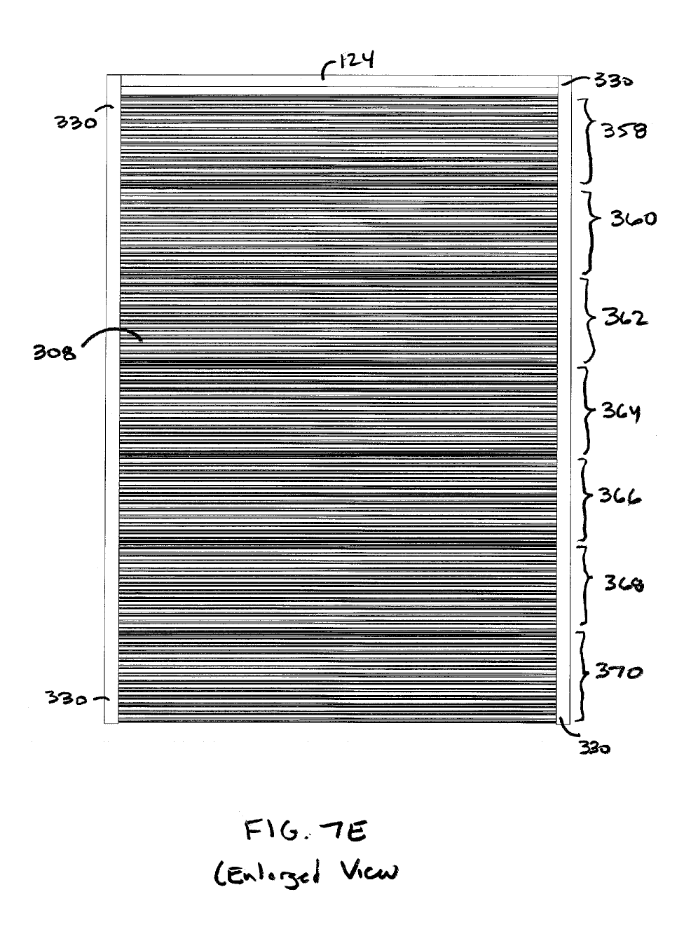

Side security panels 304, 306 and rear security panel 308 are comprised of flat overlapping steel panel sections in the embodiment of the present invention shown in FIG. 3. In an alternative embodiment, side security panels 304, 306 and rear security panel 308 are corrugated or ribbed steel panels (see FIG. 7). More specifically, side and rear security panels 304, 306 and 308 in this embodiment are formed from multiple panel sections 358, 360, 362, 364, 366, 368 and 370 of roll-formed 26-gauge, grade 80, galvanized steel, each panel section 358 through 370 being approximately 20″ in length (the length of the section is the direction that runs perpendicular to the panel corrugations). The security panels are finished with a siliconized polyester finish in this embodiment.

Each corrugated panel section 358 through 370 includes a hooked-hem seam (not shown) along its upper and lower width-wise edges (e.g., the edges that runs parallel with the panel corrugations), the hook of the hem seam facing in one direction along the top edge of the panel sections and facing in the opposite direction along the bottom edge of the panel sections.

Left and right side security panels 304, 306 and rear security panel 308 are all attached to pallet rack 100 in the same manner in the embodiment of the present invention shown in FIG. 7. Attachment of right side security panel 306 will thus be described for illustrative purposes with it being understood that left side security panel 304 and rear security panel 308 are attached in a similar manner to pallet rack 100.

Attachment of right side security panel 306 to vertical upright frame 106 of pallet rack 100 begins with the attachment of first panel section 358 mounted near the top of vertical upright frame 106 (see FIG. 7D). More specifically, upper panel section 358 is attached to front and rear vertical upright posts 108, 110 with the hook of its upper width-wise seam facing into pallet rack 100. Panel section 358 is attached to front and rear vertical upright posts 108, 110 using a plurality of Tek screws (not shown) in one embodiment of the present invention.

With top panel section 358 of side security panel 306 already mounted to pallet rack 100, each of the remaining lower panel sections 360 through 370 of side security panel 306 is connected to the panel section directly above it by sliding the hook on the top edge seam of such panel section over the hook along the bottom edge seam of the panel section directly above it. This process continues until the bottom edge of lowermost panel section 370 is located just above the floor. It should be noted that in some cases, depending on the particular height of pallet rack 100, it may be necessary to cut the bottom panel section along its width in order avoid having the bottom panel section 370 contact the floor.

With all of the panel sections 358 through 370 hanging from each other along the side of pallet rack 100, the bottom edge of lowermost panel section 370 is pulled downward until it touches the floor thus engaging the seams of each above panel section with each other (in this embodiment, there generally is enough play in the mating seams along the edges of the hanging panel sections to allow for approximately 1″ of downward stretching movement after the panel sections have been hung from each other). Once stretched, each of the panel sections 360 through 370 is secured to front and rear vertical upright posts 108, 110 of pallet racking 100 using two to four Tek screws per panel (not shown) in this embodiment.

As previously noted, left side security panel 304 and rear security panel 308 are mounted to pallet rack 100 in a manner similar to right side security panel 306 in this embodiment of the present invention.

It should be understood that although side and rear security panels 304, 306 and 308 are shown and described herein using specific materials and as having specific components and configurations, the present invention is not limited to these materials or to these particular components or configurations. In other embodiments of the present invention, other materials and other components and configurations are used for the security panels. For example, in alternative embodiments of the present invention, non-metal panels or plastic panels are utilized, non-corrugated panels or flat panels are utilized, and/or continuous panels (e.g., panels not made from individual seamed panel sections) are used.

It should also be understood that although the various embodiments of the present invention have been described herein utilizing particular types of fasteners, the present invention is not limited to construction using these particular fasteners and in other embodiments of the present invention, other types of fasteners and connectors are utilized.

As previously described above, door guides 316 and 318 are mounted to pallet rack 100 such that these guides are located outward from front vertical upright posts 108 and pallet rack 100. Mounting door guides 316 and 318 outside of pallet rack 100 in this manner allows door curtain 336 of roll-up door assembly 302, which is mounted inside of pallet rack 100, to be unrolled or closed without hitting or running into front middle and lower horizontal lower load beams 126 and 130 when door curtain 336 is unrolled or in the closed position.

In order to prevent outward protruding guides 316, 318 from being snagged or damaged by material handling equipment moving along and past the front of pallet rack 100 and security apparatus 300, it is desirable to have the front face of pallet rack security system 300 be flush or approximately flush. It is also desirable to cover-up any gaps or openings in security apparatus 300 including the gaps and openings that exist between each door guide 316, 318 and the corresponding vertical upright posts 108 to which each is attached.

To accomplish this, a corner jamb or corner trim member 328 formed from high strength 18-gauge galvanized steel is attached to the back side of each guide 316, 318 along its entire length from near the top of pallet rack 100 to the floor using a plurality of TEK screws 372 (see FIG. 8A). Corner jamb members 328 are also tapered or angled in this embodiment to further reduce the likelihood that the corner edge of pallet rack security apparatus and system 300 will be damaged by material handling equipment operating in the vicinity of pallet rack 100. Other configurations and other materials are used for the corner jambs and trim members in other embodiments of the present invention.

In addition to being attached to its respective door guide on the front side of pallet rack 100, each corner jamb member 328 is also attached to its corresponding front vertical upright post 108 of pallet rack 100 on the side of pallet rack 100. More specifically, corner trim members 328 are disposed to overlap side security panels 304, 306 on the side of pallet rack 100) see FIGS. 3 and 7). Security fastener bolts 374 and their accompanying security nuts 376 (see FIG. 8) are used to secure each corner trim member 328 to its respective front vertical upright post 108 with the edge of the respective side security panel 304, 306 secured by being sandwiched between the corner trim member 328 and the vertical upright post 108. Security fasteners 374 in this embodiment have special security heads that are provided to prevent tampering and removal of corner jamb members 328. It should be noted that in other embodiments of the present invention, other materials and other types of fasteners are used for and with corner jamb members 328.

To close off the back corners of pallet rack security apparatus and system 300, rear corner trim members 330 are provided on each rear corner of pallet rack 100 (see FIGS. 3 and 7). More specifically, and with reference to the left rear corner of pallet rack 100, a right-angle rear corner trim member 330 is disposed along this rear corner in overlapping relationship with side security panel 304 and rear security panel 308. Security fasteners similar to bolts 374 and nuts 376 (see FIG. 8) are used to attach each leg of this right-angle rear corner trim member to left rear vertical upright post 110 of pallet rack 100. In this way, the edges of side security panel 304 and rear security panel 308 are secured by being sandwiched between a rear corner trim member 330 and rear vertical upright post 110.

A second rear corner trim member 330 is similarly attached to the other rear corner of pallet rack 100 to secure the edges of right side security panel 306 and rear security panel 308 thereby providing for a complete and secure enclosure around pallet rack 100.

Finally, header 310 is attached to pallet rack security system 300 by wedging or sliding the bent ninety-degree ends of header 310 into the small gap that exists between the back side of each door guide 316, 318 and the corresponding corner jamb 328 attached to it (see FIGS. 3 and 7). Header 310, which is formed from 18-gauge galvanized steel in one embodiment of the present invention, and is made and formed from other materials in other embodiments, is attached to the back side of door guides 316, 318 using a plurality of Tek screws (not shown) in this embodiment. In an alternative embodiment, the bent ninety-degree top edge of header 310 rests on top edges of door guides 316, 318 and header 310 is attached to the door guides from the front of header 310 using Tek screws (not shown).

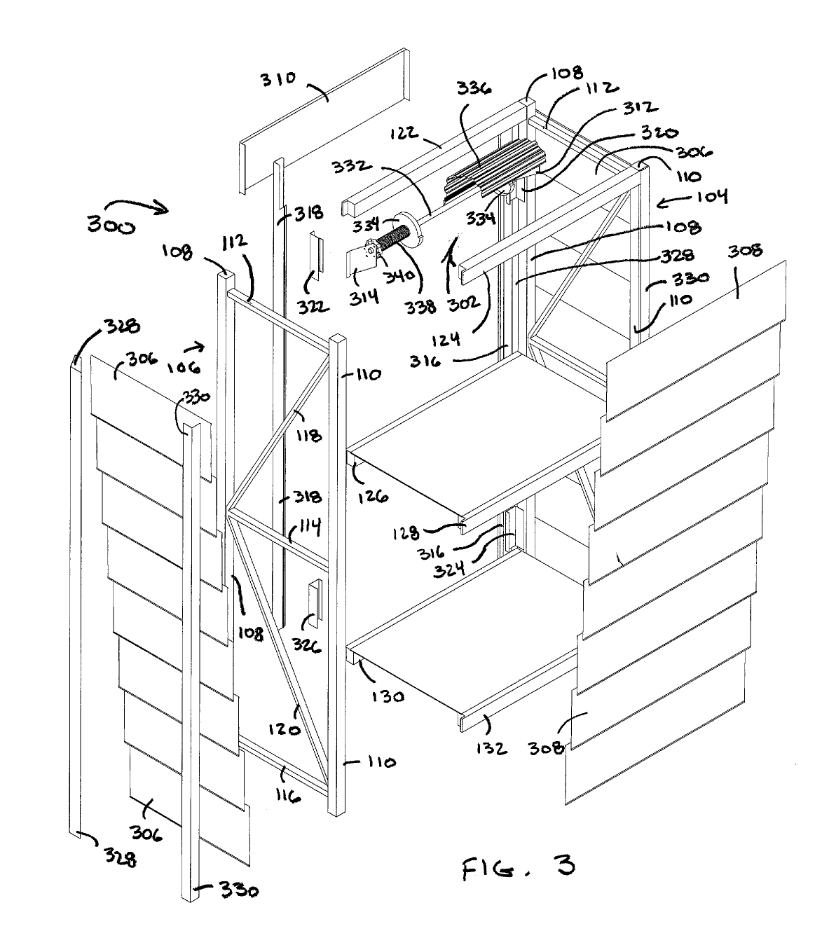

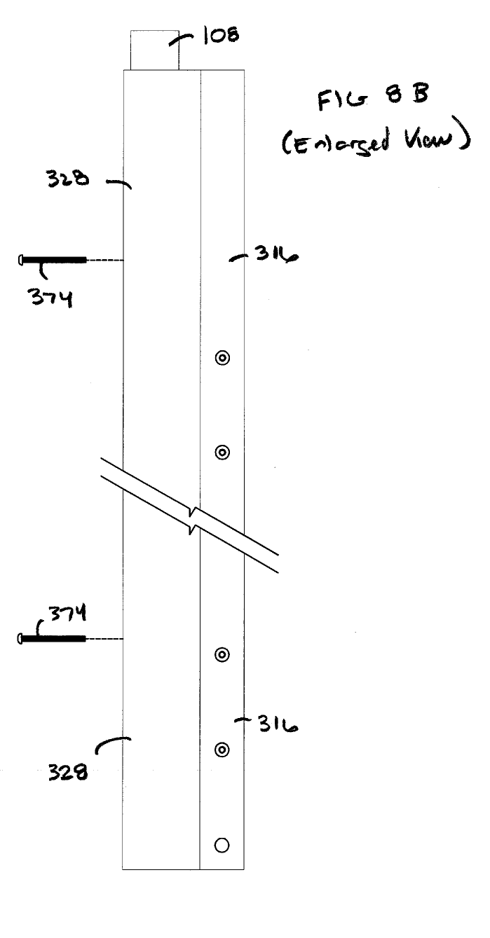

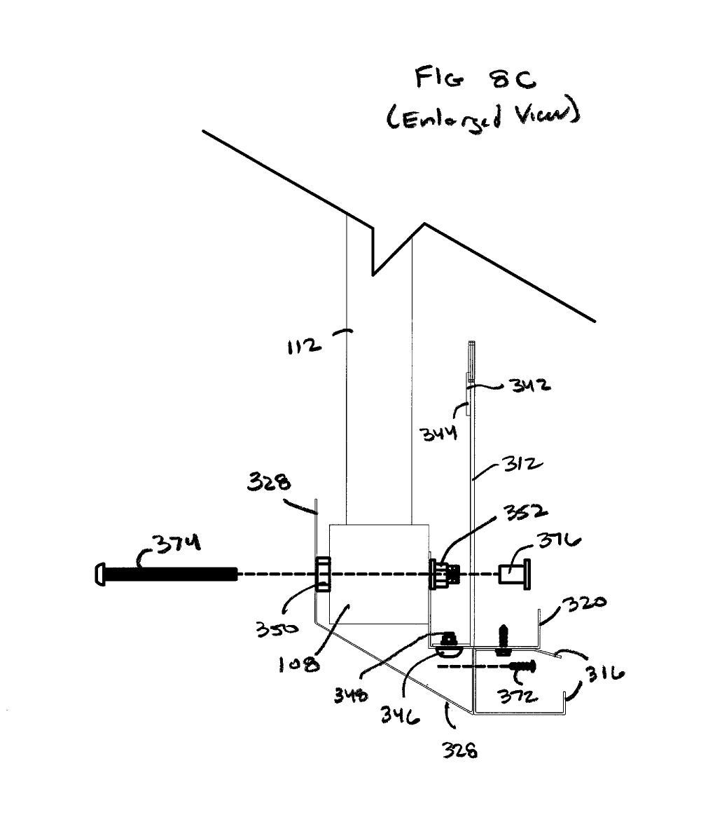

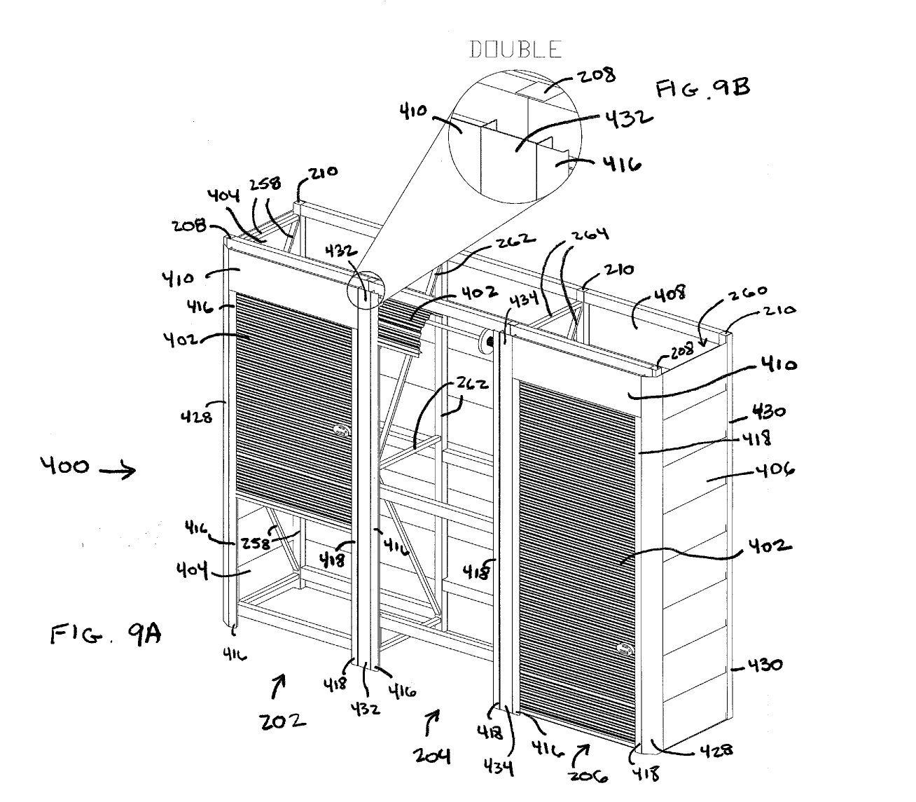

A pallet rack security apparatus and system 400 according to another embodiment of the present invention is shown in FIG. 9. Pallet rack security apparatus and system 400 is shown enclosing a multi-bay pallet rack such as, for example, multi-bay pallet rack 200 shown in FIG. 2. Pallet rack security apparatus and system 400 in this embodiment includes three separate roll-up door assemblies 402 (only one of which is visible in FIG. 9), one for each of the storage bays 202, 204 and 206 of pallet rack 200.

It should be understood that although security apparatus and system 400 is shown in FIG. 9 having a separate door assembly 402 for each pallet rack storage bay 202, 204 and 206, the present invention is not limited to this particular configuration. For example, in other embodiments of the present invention, a single door assembly is provided to secure all three storage bays 202, 204 and 206. In this last embodiment, the door assembly spans across the entire front of pallet rack 200 between the two vertical upright frame members 258 and 260 (see FIG. 2). In another embodiment, two separate door assemblies are used, one of which is provided to secure storage bay 202 and the other of which is provided to secure storage bays 204 and 206.

The construction of pallet rack security apparatus and system 400 is similar in many ways to the construction of pallet rack security apparatus and system 300 shown in FIG. 3. For example, pallet rack security apparatus and system 400 includes side security panels 404, 406 and a rear security panel 408. Each of these security panels are similar in construction to security panels 304, 306 and 308 of pallet rack security apparatus 300 shown in FIG. 3 and therefore will not be described in detail herein.

It should be noted, however, that pallet rack security apparatus and system 400 only includes security panels on the outside of pallet rack 200. As such, each of the storage bays 202, 204 and 206 of pallet rack 200 remain open to the other two storage bays of pallet rack 200. In an alternative embodiment of the present invention, internal security panels are attached to one or both of middle upright frames 262 and/or 264 in order to isolate and secure one or more of storage bays 202, 204 and 206 from each other.

Rear security panel 408 in this embodiment remains a single security panel that extends along the entire back side of pallet rack 200 between vertical upright frames 258 and 260. In an alternative embodiment of the present invention, rear security panel 408 is comprised of three separate security panels (e.g., one for each storage bay), one of which extends between and is attached to left side vertical upright frame 258 and middle vertical upright frame 262, another of which extends between and is attached to right side vertical upright frame 260 and middle upright frame 264, and the last of which extends between and is attached to middle vertical upright frames 262, 264.

Vertically oriented elongated trim member strips (not shown) are used in this embodiment to secure the vertical edges of the rear security panels not located at the corners of pallet rack 200. For example, elongated trim member strips are used to secure the vertical edges of the rear panel sections attached to the vertical upright posts 210 of middle vertical upright frames 262, 264 by sandwiching those edges between the trim member strips and the vertical posts. Security fasteners similar to fasteners 374, 376 having special security heads are used to secure the trim member strips to upright posts 210 in this embodiment.

Pallet rack security apparatus and system 400 also includes a pair of door guides 416, 418 for guiding each door 402, a header 410 for each storage bay, a pair of corner jamb members 428, one disposed on each front corner of pallet rack 200, and a pair of rear corner trim members 430, one disposed on each rear corner of pallet rack 200. The construction and attachment of door guides 416, 418, headers 410, corner jambs 428, and rear corner trim members 430 are all similar to the construction and attachment of door guides 316, 318, header 310, corner jambs 328, and rear corner trim members 330 respectively of pallet rack security apparatus 300 shown in FIG. 3 and therefore will not be described further herein.

In addition to these components, pallet rack security apparatus and system 400 also includes an additional jamb or trim member disposed between adjacent storage bays to close off the gaps and openings between the back sides of adjacent door guides 416, 418 and the front vertical upright posts 208 to which they are mounted. More specifically, a jamb member 432 as shown in FIG. 9 is disposed between the back side of the right door guide 418 of storage bay 202 and the back side of the left door guide 416 of storage bay 204 (see FIG. 9B). Similarly, a second jamb member 434 is disposed between the back side of the right door guide 418 of storage bay 204 and the back side of the left door guide 416 of storage bay 206. Jamb members 432 and 434 are attached to the back sides of each adjacent door guide along their length using a plurality of TEK screws.

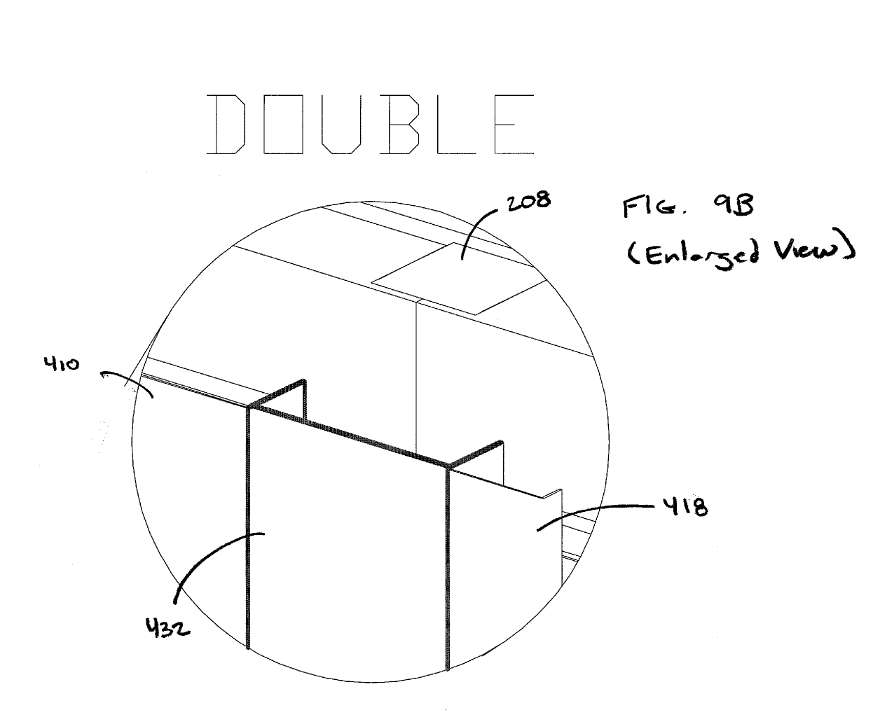

A pallet rack security apparatus and system 500 according to another embodiment of the present invention is shown in FIG. 10. Pallet rack security apparatus and system 500 is also shown attached to a multi-bay pallet rack such as, for example, multi-bay pallet rack 200 shown in FIG. 2. Pallet rack security apparatus and system 500, although mounted to multi-bay pallet rack 200, only secures a single bay of the multi-bay rack, namely, the middle storage bay 204 in this embodiment. In other embodiments, one or more of the other bays of pallet rack 200 are secured using the security apparatus and system of the present invention.

The construction of pallet rack security apparatus and system 500 is similar in many ways to the construction of pallet rack security apparatus and system 300 shown in FIGS. 3 and 7. For example, pallet rack security apparatus and system 500 includes side security panels 504, 506 and a rear security panel 508. Each of these security panels are similar in construction to security panels 304, 306 and 308 of pallet rack security apparatus 300 shown in FIG. 7 and therefore will not be described in any great detail herein.

It should be noted, however, that because side security panels 504 and 506 are mounted internally inside of pallet rack 200 to middle vertical upright frames 262 and 264, each of these panels has to be notched at various locations to accommodate front and rear horizontal load beams 234, 236, 238, 240, 242 and 244 of storage bay 204 (See FIGS. 10 and 2). It should also be noted that side security panels 504 and 506 are disposed inside of storage bay 204 in this embodiment (e.g., side security panel 504 is mounted to the right side of vertical upright frame 262 and side security panel 506 is mounted to the left side of vertical upright frame 264). In an alternative embodiment, side security panels 504 and 506 are disposed on the outside of storage bay 204 (e.g., side security panel 504 in this alternative embodiment is mounted to the left side of vertical upright frame 262 and side security panel 506 is mounted to the right side of vertical upright 264).

Rear security panel 508 in this embodiment is a single seamed security panel that extends between and is attached to middle vertical upright frames 262 and 264 to secure the back side of storage bay 204 in this embodiment. Vertically oriented elongated flat trim member strips (not shown) are used in this embodiment to secure the vertical edges of rear security panel 508 to pallet rack 200. More specifically, these trim member strips are used to secure the left and right vertical edges of rear panel 508 by sandwiching those edges between the trim member strips and the rear upright posts 210 of vertical upright frames 262 and 264. Security fasteners similar to fasteners 374, 376 having special security heads are used to secure the trim member strips to upright posts 210 in this embodiment.

Pallet rack security apparatus and system 500 also includes a door assembly 502 having a roll-up door curtain 536 in this embodiment, a pair of door guides 516, 518 for guiding door curtain 536, and a header 510. The construction and attachment of door assembly 502, door guides 516, 518, and header 510 are all similar to the construction and attachment of door assembly 302, door guides 316, 318, and header 310 respectively of pallet rack security apparatus 300 shown in FIG. 3 and therefore will not be described further herein.

In addition to these components, pallet rack security apparatus and system 500 also includes an additional jamb or trim member 532 disposed adjacent to the door guides on each side of storage bay 204. Jamb members 532 are provided to close off the gaps and openings that exist between door guides 516, 518 and the vertical upright posts 208 to which each guide is mounted. Each jamb member 532 is attached to the back side of its adjacent door guide along its length using a plurality of TEK screws.

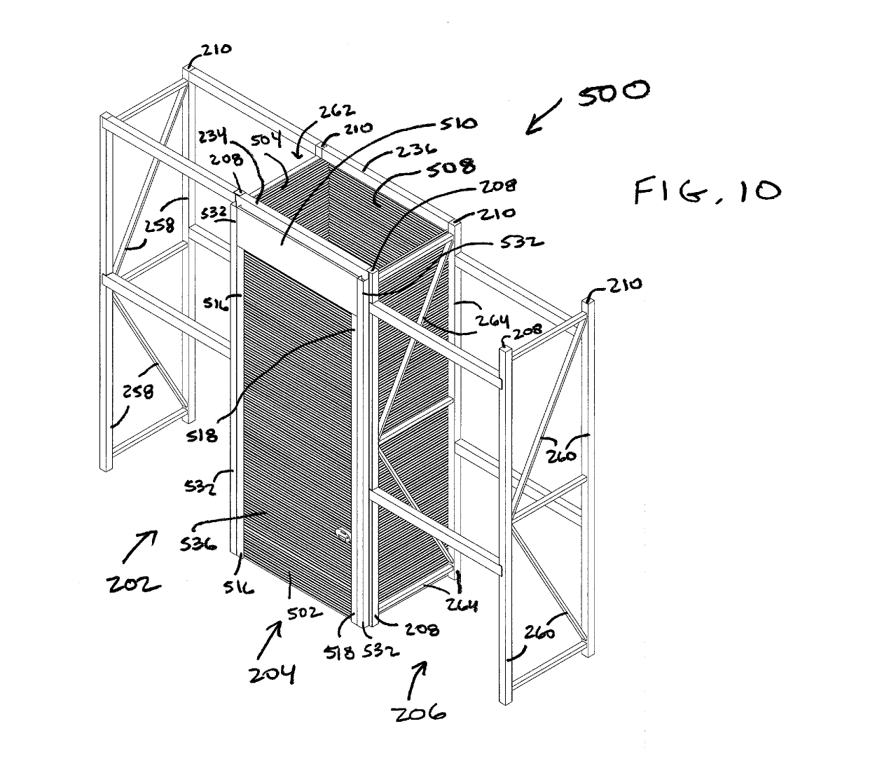

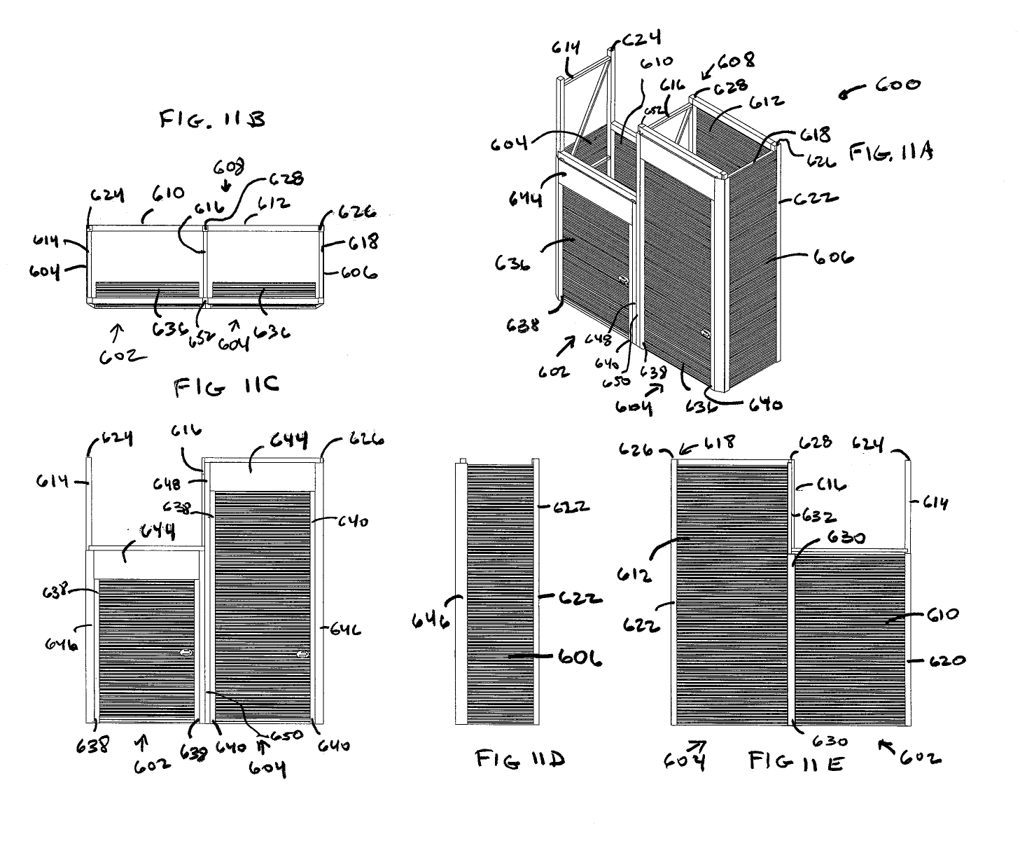

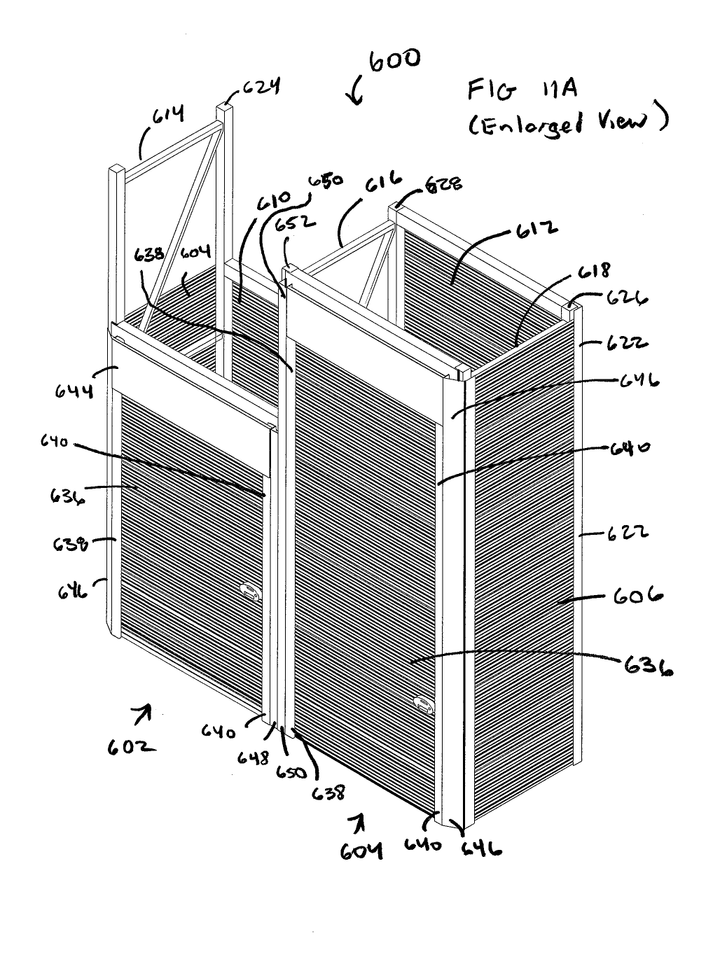

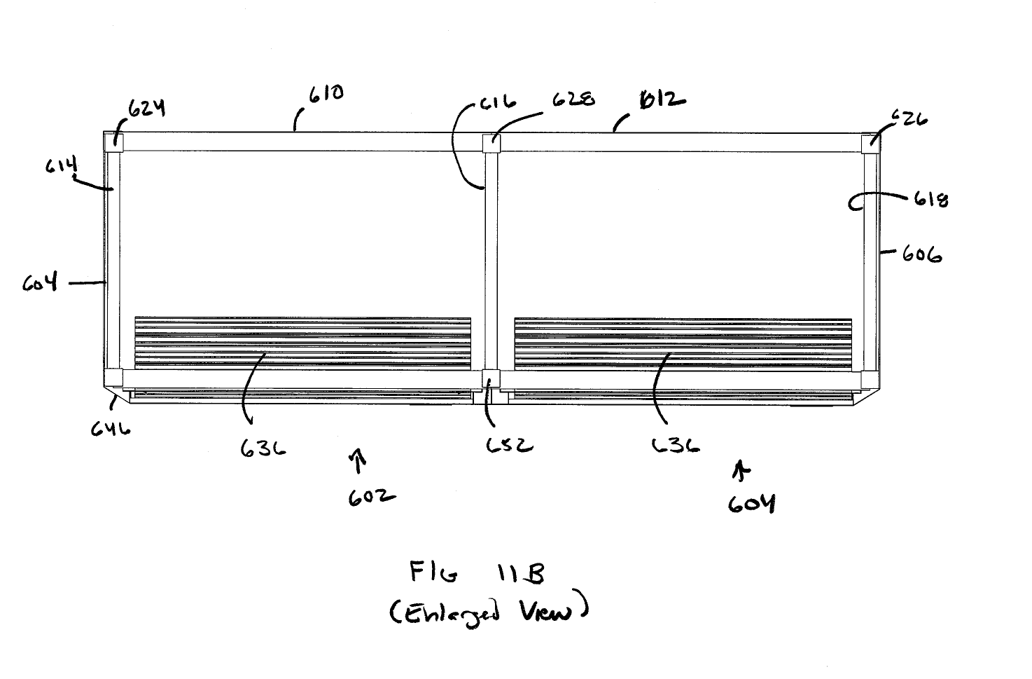

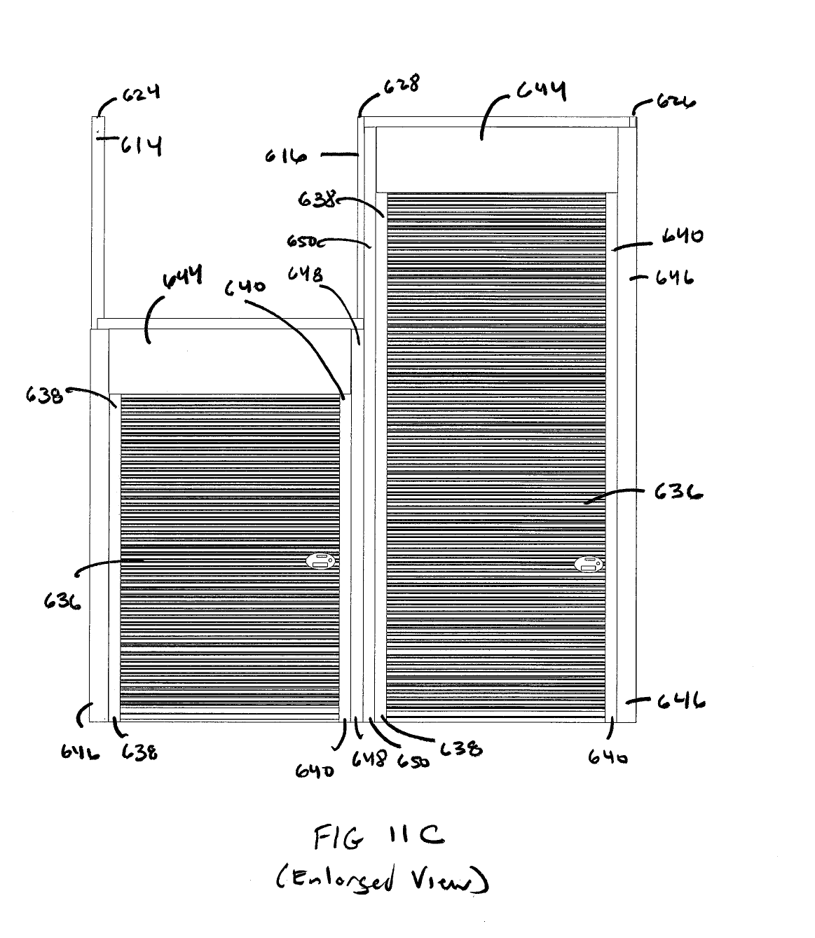

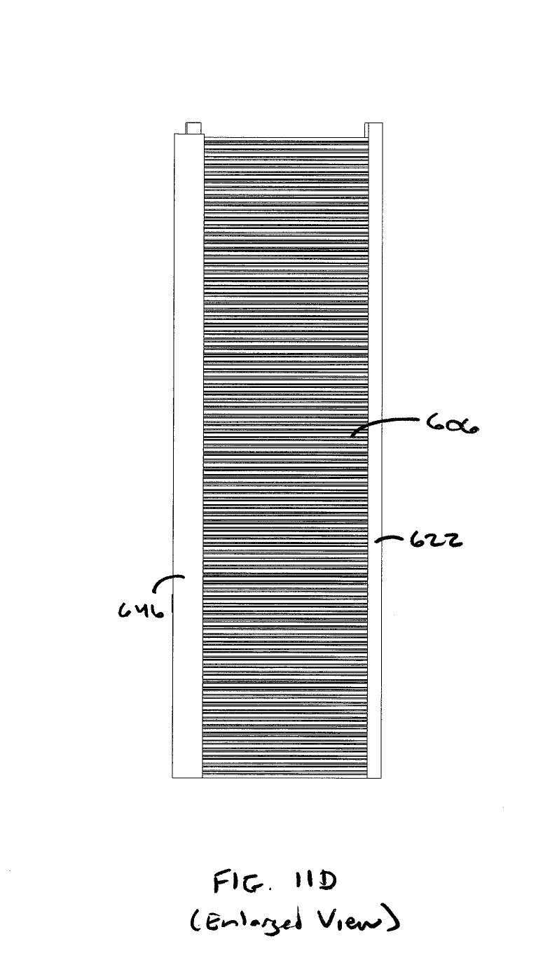

A pallet rack security apparatus and system 600 according to yet another embodiment of the present invention is shown in FIG. 11. Pallet rack security apparatus 600 includes a pallet rack having two storage bays 602, 604. Storage bay 604 is completely enclosed from top to bottom in this embodiment. Only a portion of storage bay 602, however, is enclosed in this embodiment. More specifically, only the lower levels (or shelves) of storage bay 602 are enclosed in this embodiment. In an alternative embodiment, the upper levels of storage bay 602 are enclosed while the lower levels are not enclosed.

The construction of pallet rack security apparatus and system 600 is similar in many ways to the construction of pallet rack security apparatus and system 300 as shown in FIGS. 3 and 7. For example, pallet rack security apparatus and system 600 includes side security panels 604, 606 and rear security panel 608. Each of these security panels are similar in construction to security panels 304, 306 and 308 respectively of pallet rack security apparatus 300 shown in FIG. 7 and therefore will not be described in any great detail herein.

It should be noted, however, that rear security panel 608 is comprised of two separate security panels 610, 612 (e.g., one for each storage bay), one of which extends between and is attached to left side vertical upright frame 614 and middle vertical upright frame 616, and the other of which extends between and is attached to middle vertical upright frame 616 and right side vertical upright frame 618.

To close off the back corners of pallet rack security apparatus 600, and to secure the vertical edges of security panels 604, 606, 610 and 612 located at these corners, corner trim members 620 and 622 are provided on each rear corner of security apparatus 600 (see FIG. 11). Each of these corner trim members is attached to security apparatus 600 in a manner similar to way in which rear trim members 330 are attached to security apparatus 300 as shown in FIG. 3.

Elongated trim member strips 630, 632 (see FIG. 11E) are used in this embodiment to secure the remaining vertical edges of rear security panels 610, 612 in place. More specifically the remaining vertical edges of rear security panels 610, 612 are sandwiched between trim member strips 630, 632 and vertical upright post 628 of middle vertical upright frame 616 as shown in FIG. 11E using security fasteners similar to bolts 374 and nuts 376 (see FIG. 8).

Pallet rack security apparatus and system 600 also includes a door assembly 636 for each storage bay 602, 604, a pair of door guides 638, 640 for guiding each door 636, a header 644 for each storage bay, and a pair of corner jamb members 646, one disposed on each front corner of security apparatus 600. The construction and attachment of door assemblies 636, door guides 638, 640, headers 644 and corner jamb members 646 are all similar to the construction and attachment of door assembly 302, door guides 316, 318, header 310, and corner jamb members 328 respectively of pallet rack security apparatus 300 shown in FIG. 3 and therefore will not be described further herein.

In addition to these components, pallet rack security apparatus and system 600 also includes an additional pair of jamb or trim members 648, 650 disposed between adjacent storage bays to close off the gaps and openings between the back sides of adjacent door guides 638, 640 and the front vertical upright post 652 of middle vertical upright frame 616. More specifically, jamb members 648, 650 as shown in FIG. 11 are disposed between the back side of the right door guide 640 of storage bay 602 and the back side of the left door guide 638 of storage bay 604 (see FIG. 11). Jamb members 648, 650 are each attached to the back sides of each adjacent door guide along their length using a plurality of TEK screws.

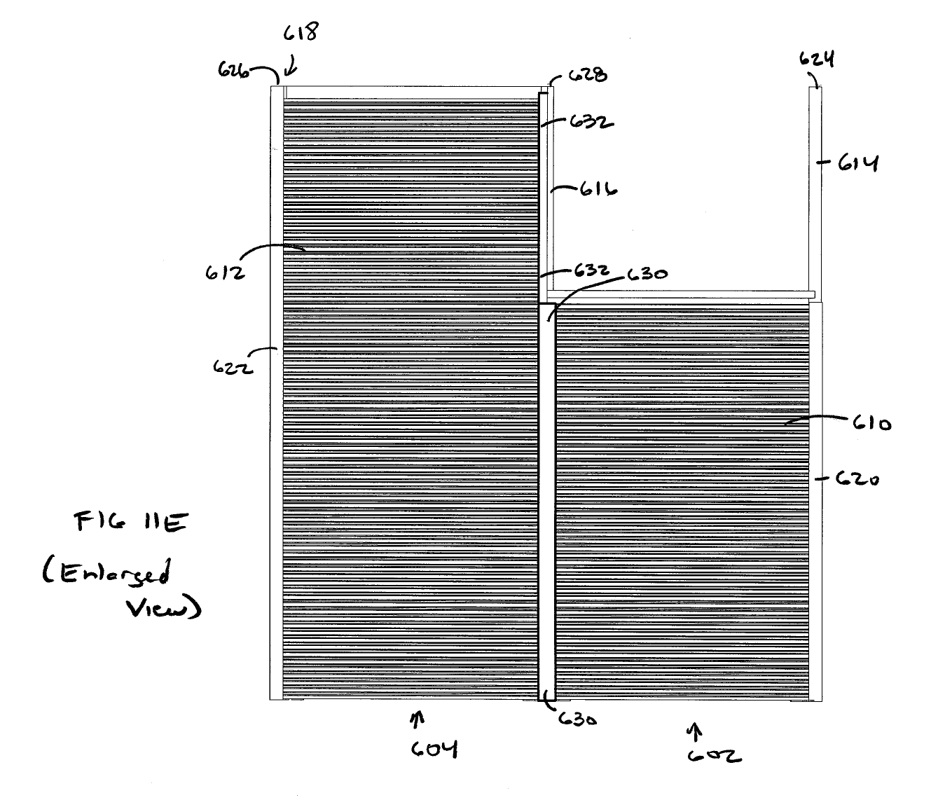

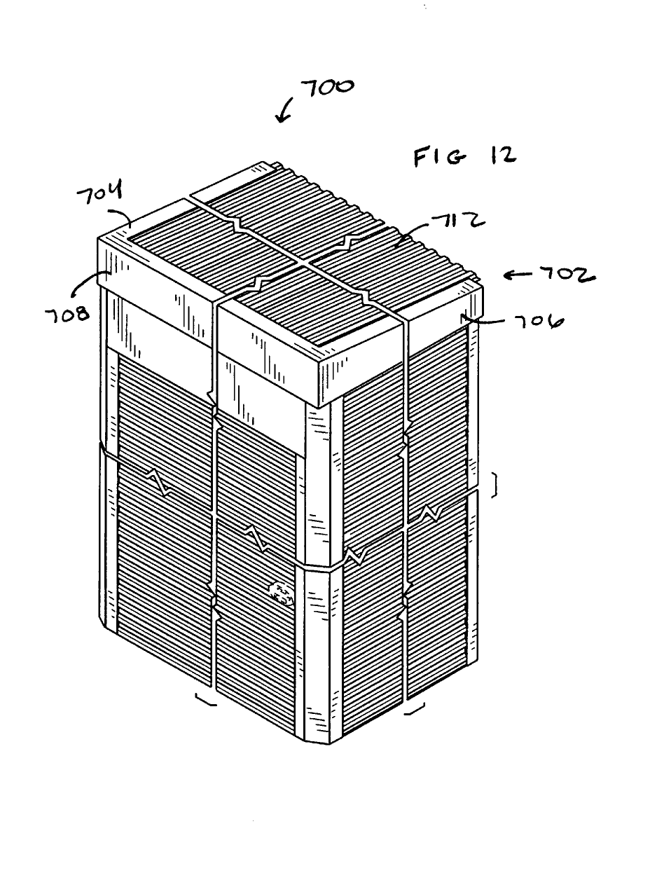

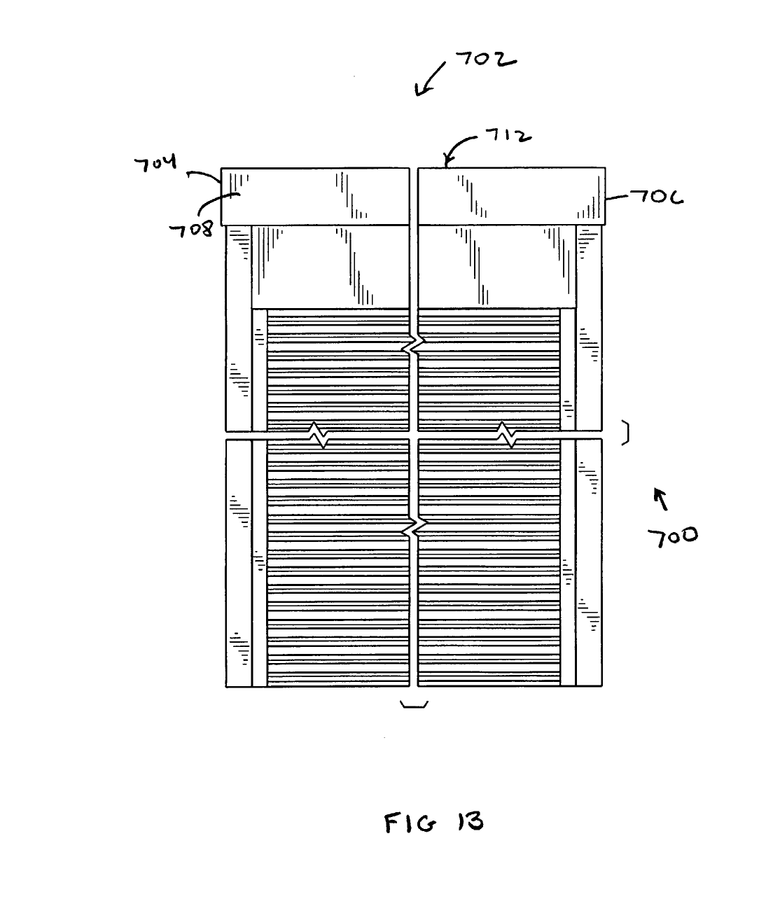

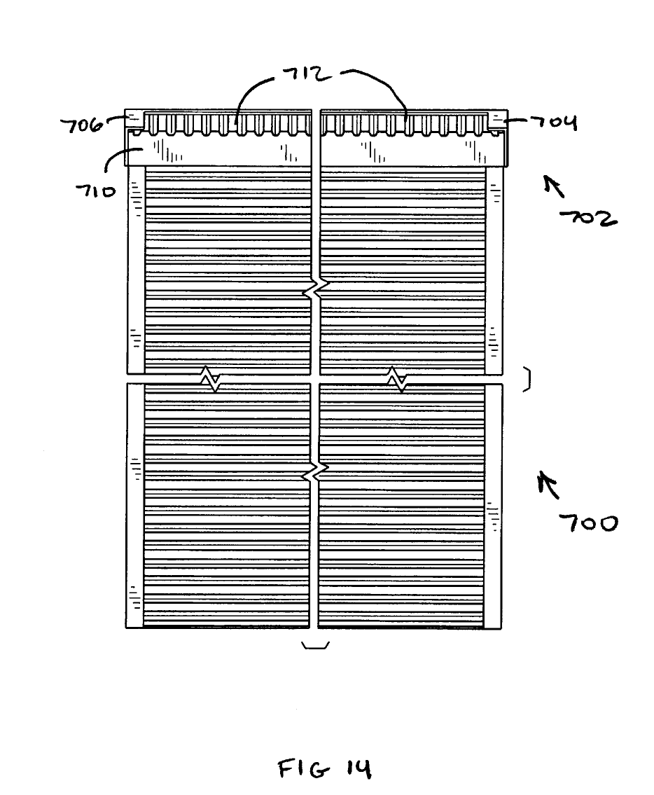

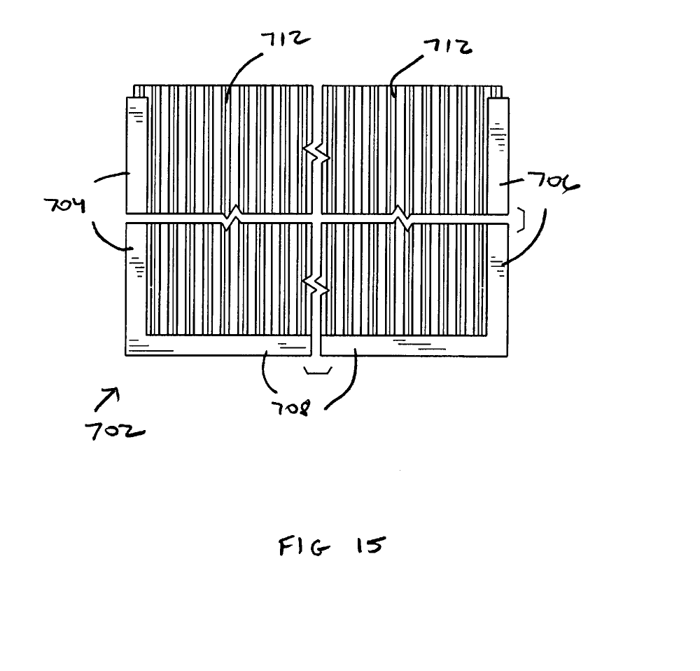

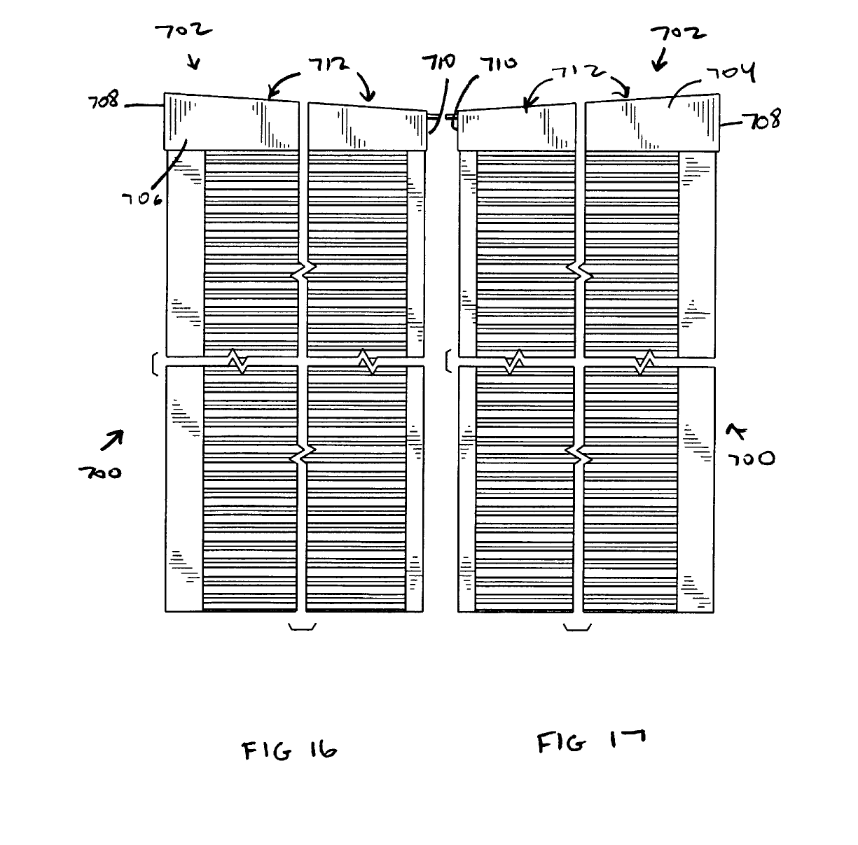

A security apparatus and system 700 according to yet another embodiment of the present invention is shown in FIGS. 12 through 17. Security apparatus and system 700 includes a cover 702 having left and right side trim members 704, 706, a front trim member 708, a rear trim member 710, and a roof panel 712. Roof panel 712 is sloped and extends outward from the back side of security apparatus and system 700 over the top of rear trim member 710. Trim members 704, 706 and 708 overlap roof panel 712 around its front and side edges in this embodiment. Foam insulation or calk are applied to the front and side edges of roof panel 712 to provide a weather tight seal between these edges and the undersides of trim members 704, 706 and 708 in other embodiments.

In another embodiment of the present invention, a drive motor and drive system are provided to automate opening and closing of the pallet rack security system's roll-up door assembly. This embodiment of the present invention allows, for example, a fork lift operator to open and close the roll-up door without having to dismount from the fork lift. The operator can simply use a remote control device to operate the door from atop the fork lift.

In one embodiment, a horizontal motor support brace is attached to one of the vertical uprights located on either side of the roll-up door. The horizontal motor support brace is connected between the two vertical upright posts of the vertical upright in this embodiment. A motor mounting bracket is attached to the horizontal motor support brace and the drive motor is in turn attached to the motor mounting bracket. The motor is operatively connected to the roll-up door assembly using a drive system such as, for example, a chain and sprocket drive system or a belt drive system.

Since the drive motor needs to be operatively connected to the roll-up door assembly, it is desirable to have the horizontal motor support brace attached to the vertical upright in a location that will permit the drive motor to be disposed near and behind the roll-up door assembly. In this position, the drive motor and drive system will be positioned so as to minimize interference with the loading and unloading of pallets and goods into and out of the bay of the pallet rack.

The apparatus and system for providing secure storage provides various advantages over existing devices and structures. The system is capable of converting existing pallet rack bays into secured storage space. The apparatus and system is also capable of attachment to both steel pallet rack systems and to wood pallet racking systems, regardless of manufacture or design. Further, the system allows secure storage of goods in the location they are used, but without requiring material handlers to retrieve the goods from secure storage rooms or areas, without utilizing areas secured with fencing that take needed floor space, and without purchasing specialized shelving or cabinets. The system also provides visual security, that is, the goods stored inside cannot be viewed when the door is closed. The system likewise provides an enclosure which protects stored goods from or reduces the accumulation and effects of outdoor as well as indoor elements, e.g., rain, snow, UV light, dirt, dust, and the like.

The door assembly for use with the apparatus and system described herein provides various additional advantages. For instance, the door may roll-up and nest inside the pallet rack bay. As a result, the door does not block an aisle when open, as would be the case with a swinging door. Likewise, the door does not block adjacent bays or other spaces when open, as a laterally sliding door may do. Door nesting inside the pallet rack bay also eliminates door damage and safety hazards from passing forklifts or other material handling equipment. The door may be motorized or driven. Accordingly, a key pad or remote may be used to operate the door. As a result, a material handler is not required to dismount equipment to store or retrieve goods. The key pad or remote may also be provided with a security function (e.g., a secure code) such that access to the pallet rack is limited or restricted to authorized individuals. Further, the driven door assembly can be used in conjunction with automated cellular and robotic operations.

Similarly the side and back panels, the trim and jambs, and roof of the apparatus and system described herein provide various advantages. For example, interlocking side and back panels may be tamper resistant, are easy to install, and reduce the accumulation and effects of indoor/outdoor elements, such as for example, light, dirt, dust, rain, snow, and the like. Moreover, the side and back panels can be sized, e.g., trimmed, to accommodate cross arms or other shelf supports carried by the pallet racking system. Trim and jamb components provided on a system prevent tampering with fasteners which may hold one or more panels or other components in place, and similarly protect goods from or reduce the accumulation and effects of indoor/outdoor elements, such as for example, light, dirt, dust, rain, snow, and the like. A roof may attach to the pallet racking system, or may attach to other shelving without the need for a separate structure to support the roof. Moreover, the roof may be sloped to direct water in a selected direction, and similarly protects goods from or reduces the accumulation and effects of indoor/outdoor elements, such as for example, light, dirt, dust, rain, snow, and the like. Accordingly, the foregoing may convert a pallet racking system into a weather-proof storage system for storing goods outside.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the system, methods, and devices as shown in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes and omissions may be made in the design, operating conditions and arrangement of the various examples of embodiments without departing from the spirit or scope of the present inventions.

While this invention has been described in conjunction with the examples of embodiments outlined above, various alternatives, modifications, variations, improvements and/or substantial equivalents, whether known or that are or may be presently foreseen, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

Numerous modifications may be made to the present invention which still fall within the intended scope hereof. Thus, it should be apparent that there has been provided in accordance with the present invention, an apparatus and system for secure storage that fully satisfies the objectives and advantages set forth above. Although the invention has been described in conjunction with specific embodiments thereof, it is evident that many alternatives, modifications and variations will be apparent to those skilled in the art. Accordingly, it is intended to embrace all such alternatives, modifications and variations that may fall within the spirit and broad scope of the appended claims.

The embodiments of the invention in which an exclusive property or privilege is claimed are defined as follows:

1. A system coupleable to a storage apparatus for storing and securing goods, the system comprising:
a sliding door assembly mountable to the storage apparatus and which nests within the storage apparatus when open, the sliding door assembly including a sliding door; and
a door guide provided on a side of the sliding door to control the path of the sliding door, and disposed to permit the door to open and close without interference from the storage apparatus.

2. The system of claim 1, wherein the sliding door assembly is a roll-up door assembly.

3. The system of claim 1, wherein the sliding door opens and closes vertically.

4. The system of claim 1 further comprising a drive assembly for opening and closing the sliding door.

5. The system of claim 4, wherein the sliding door is operable by a control device.

6. The system of claim 1 further comprising a security panel disposed on a side or rear of the storage apparatus.

7. The system of claim 6, wherein an additional security panel is disposed on an additional side of the storage apparatus.

8. The system of claim 6, wherein the security panel mounts to an existing structural framework of the storage apparatus.

9. The system of claim 1, wherein the door guide is mounted to a structural upright of the storage apparatus.

10. The system of claim 1, further comprising a trim member or jamb for covering an opening.

11. The system of claim 1, wherein the sliding door assembly nests entirely within the storage apparatus when open.

12. The system of claim 1, further comprising a roof structure.

13. A pallet rack including the system of claim 1 coupled thereto.

14. A secure storage apparatus comprising:
a pallet rack having a bay;
a roll-up door assembly mountable to the pallet rack and including a roll-up door which is disposed within the pallet rack when open, and encloses a portion of the bay when closed; and
a plurality of door guides, each door guide provided on a side of the door to control the path of the door, and disposed to permit the door to open and close without interference from the pallet rack.

15. The secure storage apparatus of claim 14, wherein the pallet rack has multiple bays.

16. The secure storage apparatus of claim 14 further comprising a security panel coupled to the pallet rack and covering a portion of the bay.

17. The secure storage apparatus of claim 16, further comprising a trim member or jamb for covering an opening.

18. A pallet rack security apparatus mountable to the existing structural framework of a pallet rack, the apparatus comprising a roll-up door mountable to the structural framework so as to nest within a portion of the pallet rack when open, the roll-up door coupled to a door guide disposed to permit the roll-up door to open and close without interference from a horizontal load beam or shelve of the pallet rack disposed directly behind the door, and a plurality of security panels coupleable to the structural framework to cover a portion of a side or rear of the pallet rack.

19. The pallet rack security apparatus of claim 18, wherein the security apparatus secures a single bay in a multi-bay pallet rack.

20. The pallet rack security apparatus of claim 18 wherein hidden tamper resistant fasteners attach the pallet rack security apparatus to the structural framework.
